(19) United States
(12) Patent Application Publication
(10) Pub. No.: US 2026/0290121 A1
(43) Pub. Date: Sep. 24, 2026

(54) SHARED PROMOTIONAL/MONETARY BINGO SYSTEM

(71) Applicant: Roxor Gaming Limited, London (GB)

(72) Inventors: Veronika Vashkevich, London (GB); Chethana Harve, North Harrow (GB); Priya Jadwani, Basingstoke (GB)

(21) Appl. No.: 19/087,155

(22) Filed: Mar. 21, 2025

(51) Int. Cl. G07F 17/32

(52) U.S. Cl. CPC G07F 17/3239; G07F 17/3269; G07F 17/329

(57) ABSTRACT

Systems for providing a free-to-play Class II gaming experience that address technical issues such as potential delay of the start of a free-to-play Class II gaming experience and/or free-to-play Class II gaming experience that is differentiated between different player value levels despite the technical difficulty of all of the players in a free-to-play Class II gaming session playing with the same number selection sets and selection order.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

In some jurisdictions, e.g., the United States of America, wagering games may be divided into distinct groups based on, for example, whether the player of such a game is playing against the house or against other players. In the United States, for example, the wagering game of bingo, in which players engage in some form of competition against each other for a prize or award, is classified as a Class II game, whereas wagering games in which players play against the house or casino, such as traditional slot machines (in which outcomes are determined by an RNG), banked card games (such as blackjack and baccarat), craps, roulette, and the like, are classified as Class III games. Class II games are, for example, regulated by tribal gaming commissions in the United States and do not require state approval. Class II games are also only subject to federal taxation, i.e., not to state taxation, in the United States. Class II games are, for this reason, often easier and less costly for a tribal casino to deploy and also provide more flexibility with regard to player payouts/operator profits (due to not having to pay state taxes on them).

While Class II games may, for example, be based on an underlying bingo game, such games may be presented to players in a format that looks, in many respects, similar or identical to some Class III games. For example, there are Class II games in which a slot-machine-like GUI is provided that mimics the look and feel of a slot machine, but where the results are determined based on the outcome of a bingo game that the player is participating in. If the player obtains a bingo award of a certain value, the GUI is caused to portray a slot machine outcome that would produce an award that matches that of the bingo game. While such games generally continue to show the bingo card (and bingo results) that drive the slot machine outcome displayed by the GUI, some such Class II games may allow a player to “hide” the bingo results, at which point the GUI may appear to be indistinguishable from an equivalent Class III game. Class II games thus offer a flexible framework to casinos for providing not only Class II-like games, but also Class III-like game play supported by a Class II game.

In the discussion below, it will be understood that, unless indicated otherwise, the Class II game play aspects discussed below are with respect to implementations of such Class II game play as disclosed in the context of this disclosure, and are not admissions of what is considered to be prior art.

In an actual, for-money Class II game, players of the game play against one another—for example, in a round (or session) of a bingo-type Class II game, each player of the game will purchase (or otherwise obtain) one or more bingo cards. Once at least two players have entered a bingo game session, e.g., by each purchasing one or more bingo cards for the bingo game session, the bingo game session may commence. The bingo cards, it will be understood, may be virtual or digital bingo cards, e.g., a data construct such as an array that stores a plurality of numbers in a random or semi-random format. For example, a typical bingo card may include a 5×5 array of numbers, with the top row of array positions filled with five numbers randomly selected (without replacement) from the range of numbers 1-15, the second row of array positions filled with five numbers randomly selected (without replacement) from the range of numbers 16-30, the third row of array positions filled with five numbers randomly selected (without replacement) from the range of numbers 31-45, the fourth row of array positions filled with five numbers randomly selected (without replacement) from the range of numbers 46-60, and the fifth row of array positions filled with five numbers randomly selected (without replacement) from the range of numbers 61-75. In some instances, one or more array positions on a bingo card may be designated as “wild” positions and may not have a number selected therefor; such positions may be treated as equivalent to any potentially drawn number. The bingo cards that are distributed to players of a bingo game may all be randomly generated, thereby introducing an element of player-specific (or, more correctly, bingo card-specific) random chance into the bingo game session.

Once at least two players for a bingo game session have all been assigned their respective bingo card or cards, actual play of the bingo game session may commence. In a bingo game session, numbers are randomly selected from the complete population of numbers that were selected from in order to populate the bingo cards for that bingo game session. Such number selection is, in a Class II context, typically done by a centralized server that selects one of the numbers in the set of numbers and then notifies devices used by players of the bingo game of the selected number. In the example provided above, the numbers on the bingo cards were selected from a population of numbers from 1 to 75. Such number selections may occur without replacement, e.g., once a number is selected from the set of numbers, that number is removed from the set of numbers for the remainder of the bingo game session such that a later selection of a number does not result in the same number being selected as was selected in a previous number selection event for the bingo game session. In some instances, there may be an initial random selection of a large quantity of numbers from the set of numbers, e.g., in a 75-number set, 40 numbers may be selected, followed by individual selections of numbers from the remaining, unselected numbers in the set of numbers.

For each number of the initial set of randomly selected numbers, e.g., the initial set of 40 numbers, that is selected and provided to the devices used by the players of the bingo game, a determination is made by each player's device as to whether the selected number matches any of the numbers stored in any of the array positions that represent the player's bingo card and following the determination a subsequent determination may be made as to whether the matched (“daubed”) numbers form one or more predetermined patterns (in other words, do the locations in a bingo card having numbers that match the numbers selected for the bingo game form a pattern that matches a predetermined bingo pattern?). The subsequent determination may be made after each number selection or after all of the initial number selections have been made. If the array positions of such matching numbers in a particular bingo card match one or more predetermined non-game-ending bingo patterns for the bingo session, then a bingo interim pattern has occurred and the player associated with the bingo card with the interim bingo pattern is awarded a prize or award. In Class II games, the prize or award is typically credits that are convertible to cash or outright cash. In at least some Class II games, there may be a limited number of prizes or awards that players may be able to win within a given session. For example, there may be a plurality of different predetermined bingo patterns, each associated with a different prize or award that is won by the player to claim a bingo interim pattern win for the associated predetermined bingo pattern. In some instances, there is also a “game-ending” pattern that, once obtained by a player, ends the bingo game session. The game-ending pattern may, for example, be a “blackout” pattern in which the number in each array position in a given bingo card array has been selected (or is a “wild” array position).

However, one issue that Class II games may have as compared with Class III games is the perception that Class II games have comparatively lower winning odds that make it difficult to obtain interim wins (e.g., non-game-ending wins) and game-ending wins. This makes it challenging to attract new players to Class II games and to retain existing players. One strategy for attracting new players and retaining existing players for Class II games is to provide free-to-play versions of such Class II games. Such free-to-play game experiences may give players an opportunity to explore different game types with little or no risk or new players an opportunity to ease into playing such games without taking large risks. Such free-to-play games may provide competitive and engaging experiences for players in a risk-free environment.

Providing a free-to-play experience in a Class II game format, however, is somewhat challenging—the free-to-play versions of such Class II games should, ideally, operate in a manner that is very similar to how the actual, for-money Class II games that they are intended to simulate operate. Moreover, in order to make such free-to-play versions of such Class II games appealing, it is desirable to make players of such free-to-play versions of Class II games able to win some form of award when playing such free-to-play versions of Class II games. At the same time, it may also be desirable to limit players' ability to play in the free-to-play versions of Class II games—after all, the principal reason for offering such free-to-play versions of Class II games is to drive additional players to play actual, for-money Class II games, or to keep players that already play actual, for-money Class II games from losing interest in such games—if players are provided with copious opportunities to play free-to-play Class II games (especially ones that may provide prizes or awards that are redeemable for various items of value), they may focus on playing the free-to-play Class II games over the actual, for-money Class II games.

In view of the above, free-to-play Class II games may generally be configured to offer players a rate-limited opportunity for play. For example, free-to-play Class II games may be configured to allow a given player only a limited number of plays per day, per week, or per some other fixed period of time.

As noted earlier, Class II games operate differently from Class III games—they involve play by at least two players competing against one another (and any additional players participating in the same Class II game session) to achieve a game-ending win. Accordingly, in order to provide a gaming experience similar to Class II gaming, the free-to-play Class II game may be configured to operate in a similar manner, e.g., with free-to-play players being provided with bingo cards (or virtual bingo cards) and then a central determination system being used to select numbers from the set of numbers used to populate the bingo cards.

One issue with the above approach, however, is that due to the potential restrictions on free-to-play play by players that may limit the number of plays of the free-to-play Class II game, the number of players that may be available at any one time to play the free-to-play Class II game may be significantly reduced from the typical numbers of players that are available for a for-money Class II game. This results in a technical challenge, as it may take much longer for the number of players waiting to play a free-to-play Class II game to reach the minimum number of players, i.e., two players, that are required before starting the free-to-play Class II game as compared with the wait time encountered by players playing in a for-money Class II game context.

A technical solution to this issue is to, in effect, run a free-to-play Class II game and a for-money Class II game in parallel such that each number selected from the set of numbers for the bingo cards is provided at the same time to devices playing either the free-to-play Class II game or the for-money Class II game. Since there is generally no cap on how frequently a player can play a for-money Class II game, there are typically much shorter “queue times” for a for-money Class II game than there would be for a play-limited free-to-play Class II game. By combining the free-to-play Class II game and the for-money Class II game in parallel and allowing players from both the free-to-play Class II game and the for-money Class II game to satisfy the minimum two-player requirement at least for the free-to-play Class II game play, the wait time for a player to play the free-to-play Class II game may be significantly reduced, thereby avoiding a situation where a player waiting for a free-to-play Class II experience is kept waiting for an undesirably long period of time that may discourage them from engaging in further Class II experiences—either of the free-to-play or for-money variety.

In implementations in which players of the free-to-play context Class II game are not allowed to complete the game-ending pattern but the for-money players are allowed to complete the game-ending pattern, the combined free-to-play and for-money Class II game session may not begin until there are at least two for-money context Class II game players waiting to join the Class II game session. In implementations in which players of both the free-to-play players and the for-money players are both allowed to complete the game-ending pattern for the Class II game session, the Class II game session may begin when there are two players waiting to participate in the Class II game session, regardless of whether each such player is participating in a for-money or free-to-play context. It will be noted that in implementations in which players in both the free-to-play and the for-money context are both allowed to complete a game-ending pattern, there may nonetheless be differences in how each type of player may go about completing such a game-ending pattern. For example, in some implementations, players participating in a Class II game session in a free-to-play context may only be allowed to claim completion of a game-ending pattern after a specified number of numbers has been selected, e.g., 73, 74, or 75 numbers from a 75-number pool. The players participating in a for-money context may, in contrast, be allowed to complete the game-ending pattern at any time during the Class II game session once they have satisfied the pattern requirements. In some other implementations, players participating in a Class II game session in a free-to-play context may only be allowed to claim completion of a game-ending pattern before a specified number of numbers has been selected, e.g., 63, 64, or 65 numbers from a 75-number pool. The players participating in a for-money context may, as discussed above, be allowed to complete the game-ending pattern at any time during the Class II game session once they have satisfied the pattern requirements. It will also be understood that the value of an award associated with completion (and claiming) of the game-ending pattern may also be decreased in value as the quantity of numbers selected in the Class II game session increases. For example, by the time 73 of 75 numbers have been selected, the award that may be awarded for completion of the game-ending pattern may be significantly reduced, e.g., worth only a token amount, such as a few cents. In contrast, the award may, prior to such a threshold quantity of numbers being selected, be significantly more, e.g., on the order to an amount equivalent to dollars, tens of dollars, hundreds of dollars, etc.—however, only the for-money context players may be allowed to actually win the game-ending pattern award when it is at this level. Such arrangements may facilitate compliance with Class II regulations while still allowing for players in the free-to-play context to experience short wait times for a Class II game session.

Another technical issue that may arise in free-to-play Class II games is that of being able to provide differentiated play experiences to players in the free-to-play Class II games based on various particulars of the players. For example, it may be desirable to tune the free-to-play Class II gaming experiences of players so that some players may, on average, win more often and/or win more than other players when playing the free-to-play Class II game. Such tunability may be used to deter players that “freeload,” e.g., play only the free-to-play Class II games with little or no play of for-money Class II games and/or reward players that are high-value, e.g., that play for-money Class II games regularly. The technical issue with doing so in a free-to-play Class II game, however, is that the same randomly selected numbers in a free-to-play Class II game are provided to all of the devices that the players in a given free-to-play Class II game are using. It is thus generally not feasible to, for example, weight the random selection of numbers that are provided to all of the free-to-play Class II players so as to favor players of one value level over players of a lower value level—since each higher-value player may have a different bingo card, number selection weightings that benefit one higher-value player may not benefit another higher-value player. Moreover, weightings that benefit one higher-value player may also end up benefiting a lower-value player. Additionally, if the free-to-play Class II game session is being provided in parallel with a for-money Class II game session, i.e., both free-to-play and for-money Class II games in the same session using the same number selections provided by a central server, altering the probability that any particular number would be selected would not be permitted for the for-money Class II game. Such technical limitations to providing value-differentiated play experiences to players in a free-to-play Class II environment do not exist in for-money Class II gaming or in free-to-play Class III gaming. In for-money Class II gaming, players within a given Class II gaming session should be treated equally without such player-value-specific weighting, while in Class III gaming, it is possible to individually tune the probabilities of particular outcomes occurring during game play-since each player of a Class III game is playing against the house, e.g., against a randomly generated number that is used solely to provide a gameplay outcome for that player as opposed to a plurality of players playing the Class III game, adjustments can be made to such outcome probabilities for each player without disturbing the probabilities established for other players of the free-to-play Class III game.

To address such technical challenges to providing for player-value-differentiated free-to-play Class II gaming experiences, one or both of two mechanisms may be employed. The first mechanism is to assign different multiplier values to players of different value levels, e.g., 2× for high-value players, 1.2× for average-value players, 1× for low-value players, and 0.1× for undesirable players. The latter category may, for example, include players that only play the free-to-play Class II games but never or almost never play the for-money Class II games. The first mechanism does not affect any individual player's odds of winning, but does have the effect of potentially modifying what is won by an individual player to be more or less valuable, based on the player's assigned value level. For example, a high-value player and an undesirable-value player that claim the same bingo pattern at the same time in the context of free-to-play Class II game session play would be provided with drastically different prizes or awards after the multipliers are applied to the prize or award associated with that bingo pattern—for example, the high-value player may be provided with a prize or award that is 20× greater than the prize or award provided to the undesirable-value player.

The second mechanism that may be used to provide a player-value differentiated free-to-play Class II gaming experience is to provide players of different value levels with different sets of bingo patterns that they are allowed to complete. For example, players that are of a high value may be allowed to complete bingo patterns from a set of bingo patterns that are relatively easy to complete, e.g., having only a handful, e.g., 2, 3, 4, or 5, of locations in the array representing a bingo card that are in the bingo pattern, whereas players of a low value may be allowed to complete bingo patterns from a set of bingo patterns that are generally harder to complete, e.g., having 9, 10, 11, or 12 locations in the array representing the bingo card. The second mechanism, owing to the relative complexities of the bingo patterns that each value level of player is allowed to complete, allows for players of various value levels to have different odds of being able to claim a bingo pattern and associated prize or award before an end-of-game pattern occurs or, in implementations in which there are limited numbers of prizes or awards available for claimants of completed non-game-ending bingo patterns, before another player claims such a bingo pattern for that same associated prize or award. In the context of this disclosure, “prize” and “award” are used interchangeably, and a reference to one will be understood as a reference to the other.

As noted above, the two mechanisms—the first in which rewards are adjusted upwards or downwards depending on player value level, and the second in which the odds of obtaining an award are adjusted upwards or downwards depending on player value level, may be practiced individually or in combination.

It will be understood that there are a variety of different ways that a for-money Class II bingo game may be conducted, depending on the format of such a game and how the game play is managed. For example, in its simplest form, players in a for-money Class II bingo game may simply compete for a single award, e.g., given to the first person that achieves a bingo pattern. In other implementations, players may be competing for a single award (by obtaining a game-ending pattern) but may be able to obtain additional, interim awards by completing non-game-ending bingo patterns before the game-ending pattern is obtained. Such implementations may, for example, be particularly well-adapted for use with slot-machine GUIs. For example, in some such implementations, each interim award that is earned by a player may cause the GUI of the slot machine that is displayed to present a corresponding winning symbol pattern in conjunction with the award. In some such implementations, a Class II bingo game having a slot machine GUI may be configured such that when a player of such a Class II bingo game chooses to “spin” the slot machine reels, the player's “spin” action actually purchases an entry into a Class II game session, i.e., the “spin” action is equivalent to the player purchasing a new bingo card for use in the Class II game session. The Class II game session may be a Class II game session that is already in progress but has not yet ended or may be a Class II game session that begins as soon as the player joins the Class II game session.

In some such implementations, the purchased bingo card is evaluated to determine which bingo pattern(s) is/are completed (if any) on that bingo card after the initial selection of numbers, and the slot machine GUI is then caused to display a slot machine game outcome that is associated with the award amount(s) that correspond to the completed bingo patterns on that bingo card. An additional evaluation may be made to determine if a game-ending pattern has been completed on the bingo card. In some such implementations, the determination of whether the game-ending pattern has been formed may be made taking into account all of the numbers selected for the Class II game session up until the moment the bingo card is provided or evaluated. For example, if there are 75 numbers in the number selection pool, the quantity of numbers selected in the initial number selection for a Class II game session is 40 numbers, and 63 numbers have been selected in total for the Class II game session by the time that a player purchases a bingo card (e.g., by pressing “spin” in the slot machine GUI) to participate in the Class II game session, the bingo card may be evaluated against the initial set of 40 numbers that were selected to determine if any interim, i.e., non-game-ending, bingo patterns were completed, but may be evaluated against all 63 numbers that were selected at the time the bingo card was purchased to determine if the game-ending pattern was completed. The slot machine GUI may then be updated to display one or more winning symbol combinations, e.g., along paylines, that result in an award equivalent to the award(s) associated with the completed non-game-ending and/or game-ending patterns that are formed on the player's bingo card.

If the player then presses “spin” again, a new bingo card is purchased and the process described above may be repeated. If a game-ending pattern has been completed on a bingo card by a player, then a new Class II game session may be initiated in between consecutive “spin” button presses by a player. For example, in some implementations, a Class II game session may last only about a minute or so, and so a player that plays a Class II game that is presented using a slot machine GUI for an extended period, e.g., 30 minutes, may actually participate in dozens of separate Class II game sessions in that time interval. Depending on the timing of when the player chooses to press the “spin” button in the GUI, the player may end up participating in some or all of the Class II game sessions for that Class II game during that interval, and may do so, for each Class II game session participated in, once or multiple times.

In other implementations, a Class II game with a slot machine GUI may be configured such that when a player initiates play of the Class II game by pressing the “spin” button, the player is issued a bingo card that is then retained and re-used for multiple “spins” of the slot machine GUI. In some such implementations, there may be multiple Class II game sessions for that Class II game running in parallel, and each press of the “spin” button causes the player to buy entry into a different one of the Class II game sessions with the same bingo card. With each entry into one of the Class II game sessions, the bingo card is evaluated relative to the number selections that have been made thus far for the Class II game session that was entered, and a determination is made as whether any non-game-ending or game-ending patterns have been made. Such a determination may be made in a manner similar to that discussed above with respect to the previous example.

In practice, there may be a variety of ways to implement a for-money Class II game, and it will be understood that the concepts discussed herein for providing free-to-play Class II game experiences are not necessarily limited to use with any particular such implementation of a for-money Class II game. In some implementations, a for-money Class II game and a free-to-play Class II game that share a common Class II game session may have similar or identical gameplay characteristics and/or GUIs, whereas in other implementations, a for-money Class II game and a free-to-play Class II game that share a common Class II game session may have distinctly different gameplay characteristics and/or GUIs while still sharing the underlying number selection being performed for the Class II game session.

These and other aspects of the concepts described herein are explored in more detail below but include at least the implementations listed at the end of this document.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a schematic of an example architecture for providing mixed for-money/free-to-play Class II gaming experiences.

FIG. 5 depicts a flow diagram for one technique for offering a free-to-play Class II game that avoids or minimizes issues with delayed start times associated with such a game that may arise due to limitations on the number of free-to-play Class II game plays that each player thereof may be eligible to participate in within a given time period.

FIG. 6 depicts a flow diagram for another technique for offering a free-to-play Class II game that avoids or minimizes issues with delayed start times associated with such a game that may arise due to limitations on the number of free-to-play Class II game plays that each player thereof may be eligible to participate in within a given time period.

FIG. 7 depicts a flow diagram for a technique for differentiating game play experiences between players of a Class II game based on different value categorizations for such players.

FIG. 8 depicts a flow diagram for another technique for differentiating game play experiences between players of a Class II game based on different value categorizations for such players.

FIG. 9 depicts a flow diagram for a third technique for differentiating game play experiences between players of a Class II game based on different value categorizations for such players.

FIG. 10 depicts a schematic of a system, similar to that of FIG. 4, for providing a combined for-money/free-to-play Class II game experience.

FIG. 11 depicts an example table for an example eligible non-game-ending pattern.

It will be understood that the examples shown in the Figures are not intended to be limiting, and that various other implementations will be apparent to those in the art.

### DETAILED DESCRIPTION

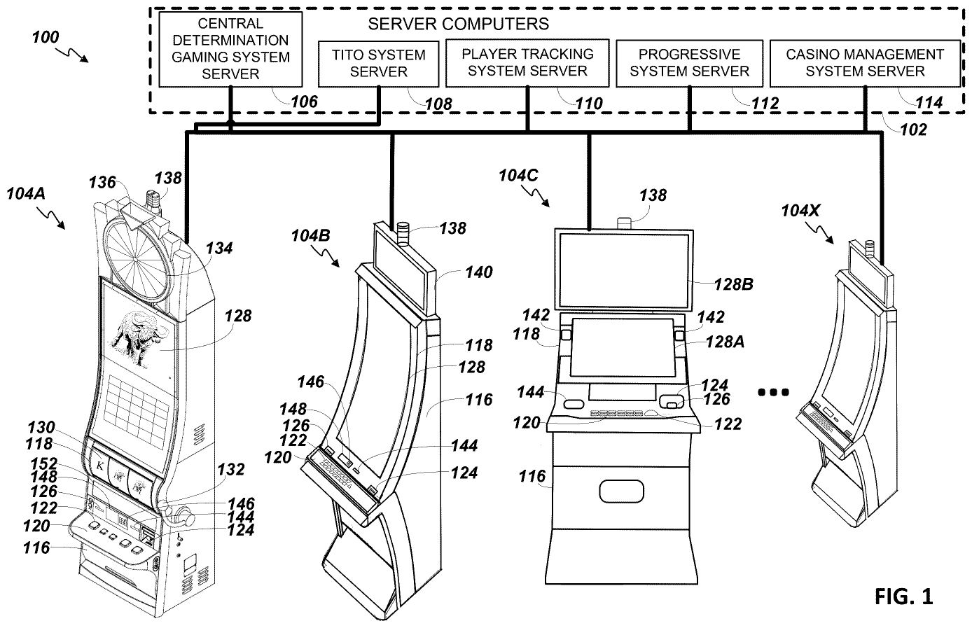

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

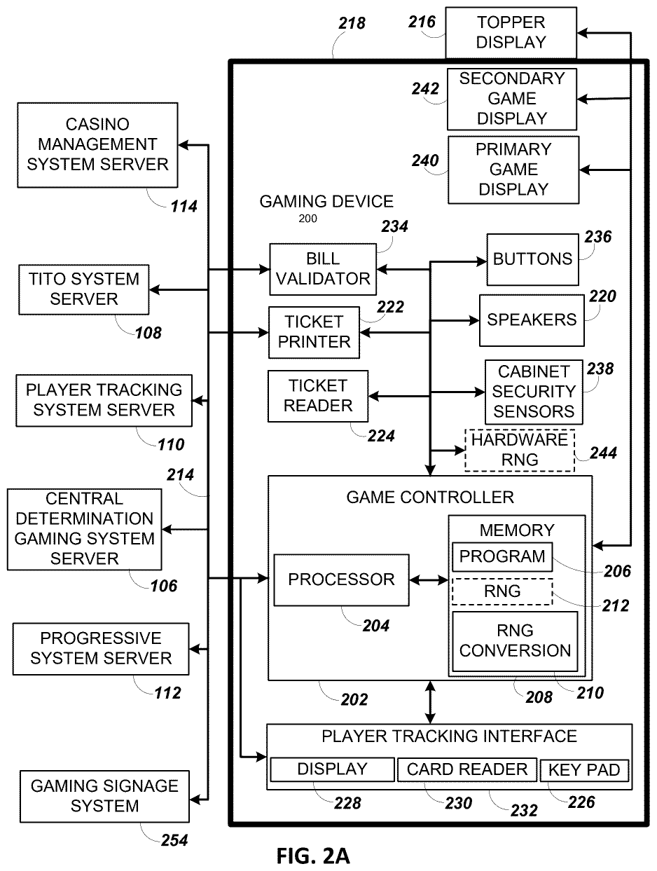

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers.

Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

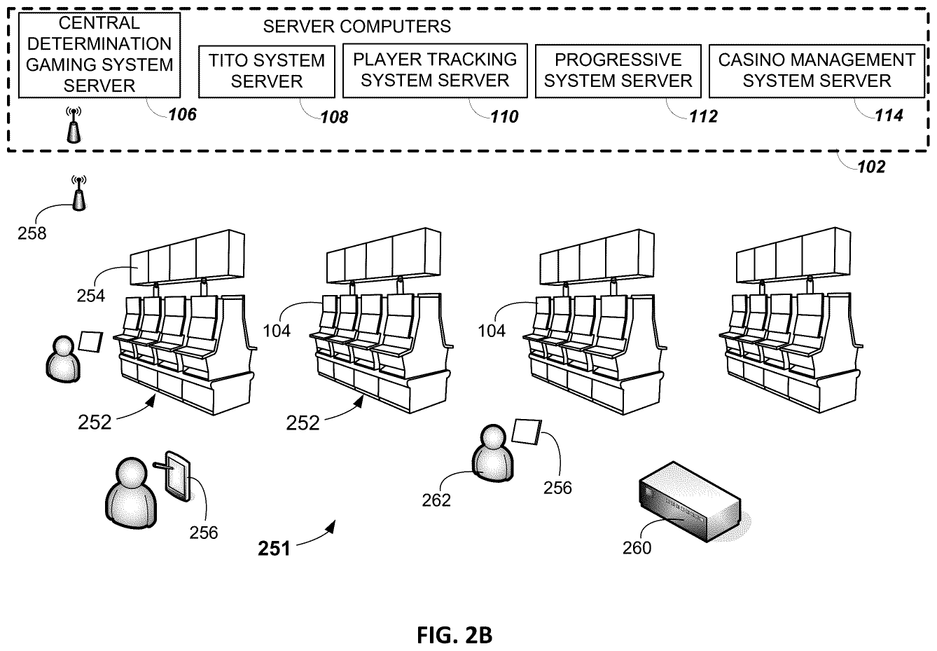

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As discussed earlier, the present disclosure is directed at systems for providing free-to-play Class II gaming experiences that are intended to serve as a mechanism to attract new users or players to for-money Class II gaming experiences and to aid in retaining the interest of existing Class II gaming players in the Class II format. While the terms Class II and Class III are used herein in the manner discussed earlier in the Summary section and are terms of art borrowed from the United States to refer to different types of gaming experiences, it will be understood that reference to Class II and Class III games extends to equivalents of such types of games in other jurisdictions that do not necessarily treat such games as being in different “classes.”

As explained in the Summary section, technical solutions to various technical problems arising from providing a free-to-play Class II play experience are disclosed in this paper. One such solution eliminates or mitigates potential delays in starting a free-to-play Class II game that may be off-putting to players, while other technical solutions discussed herein allow for player-value-differentiated free-to-play Class II game experiences to be provided to different players within a common free-to-play Class II game session despite such players all receiving the same number selections provided by a centralized number selection server. Such solutions may be used in conjunction with one another or separately, depending on the implementation.

Two types of Class II gaming experiences are discussed herein: free-to-play and for-money. A for-money Class II game, as the term is used herein, is a Class II gaming experience in which a player purchases entry to the Class II game by exchanging something of value—for example, an amount of currency, fungible tokens or vouchers that entitle the holder to play one or more for-money Class II games as if the holder had purchased such an opportunity for an amount of currency, etc. There is typically no limit on the number of times that a person may play a for-money Class II game within a given period of time (aside from, for example, potential limits established as part of a responsible gambling program in order to limit the rate at which a player may wager funds). In contrast, in a free-to-play Class II game, as the term is used herein, the opportunity to play the Class II game is, as the name suggests, free at least some of the time for a given player. For example, a free-to-play Class II game may be configured to allow each individual player up to X free opportunities to play the free-to-play Class II game within a given period of time; X may be, for example, a value such as 1, 2, 3, 4, 5, 6, 7, 8, 9, or 10, and the given period of time may be a day or a week, for example. The player may, for example, need to sign up with a player tracking account or otherwise provide information to identify the player (and to allow the player's participation in the free-to-play Class II game to be tracked), but the free-to-play opportunities would generally not require that the player exchange anything of value in order to play the X free opportunities to participate in the Class II game within the given time period. It will be understood that, in some instances, a player may be provided with the opportunity to engage in additional plays of the free-to-play Class II game within the given time period-beyond the opportunities that are provided for free-in exchange for some resource, e.g., a voucher, monetary payment, etc.

As discussed earlier, Class II games are attractive to casinos due to their separate regulatory framework and the flexibility that such games may afford to casinos. Providing free-to-play Class II games that mimic, or are in some way connected to, the game play experience of for-money Class II games may provide an avenue for improving player participation in for-money Class II games. For example, players that are unfamiliar with a particular for-money Class II game may be more willing to try a free-to-play counterpart of that for-money Class II game since there is no monetary risk to them in doing so. After playing the free-to-play version of the Class II game, such players may be more receptive to playing the for-money version of that Class II game. For existing players of a Class II game, the free-to-play version of the Class II game may offer additional opportunities to play the Class II game without incurring additional monetary risk. Moreover, free-to-play Class II games may offer as prizes, in some cases, vouchers or other mechanisms for providing a player with one or more opportunities to play a counterpart for-money Class II game as if they had paid for entry into the for-money Class II game. This may further drive additional participation in for-money Class II games.

A goal of some free-to-play Class II game systems is to provide a similar experience to what players may experience when playing a similar for-money Class II game, e.g., such as a bingo game (or a game that uses a bingo game to drive its gameplay and results, but which may present the results in a different format, such as a slot machine). As discussed earlier, one key aspect of this is the multiplayer aspect of a Class II game—this is preserved for free-to-play Class II games. As noted earlier, Class II games require at least two players in order to start. The same practice may be followed in free-to-play Class II games to make the experience of a free-to-play Class II game be representative of for-money Class II game play.

As was also noted earlier, it is also desirable to limit the number of times that players may participate in a free-to-play Class II game within a given time period. A main purpose of providing a free-to-play Class II game is to help acquire and retain players of counterpart for-money Class II games; if play of the free-to-play counterparts of such Class II games is not limited in some way, then many players may simply play the free-to-play counterpart and never migrate to the for-money version. Accordingly, while players may be provided with the ability to play free-to-play Class II games for free, such opportunities may be limited to a certain number of such free-to-play Class II game plays per given time interval, as discussed earlier. Such an approach, however, will have the technical effect of, for a given population of players, reducing the total number of players that are seeking to play a free-to-play Class II version of a for-money Class II game at any given time. This, in turn, may have the technical effect of reducing the rate at which players wishing to participate in a particular free-to-play Class II game attempt to initiate such play, which, in turn, may lengthen the amount of time it takes to gather the required minimum number of players before starting a free-to-play Class II gaming session. Such delays may be discouraging to players waiting to play the free-to-play Class II game and may result in them giving up and moving on to other activities (thereby losing a potential player and further increasing the wait time for the other players).

As discussed earlier, to address this technical issue, i.e., an increase in wait time for players waiting for a free-to-play Class II game to begin, a shared for-money/free-to-play Class II game architecture may be implemented. In such an architecture, free-to-play Class II and for-money Class II games may be run in parallel within the same Class II game session with the devices of players participating in either type of Class II game obtaining number selections, e.g., ball draws, for a bingo game from a common server or source and, in some instances, commonly competing for a game-ending pattern. As discussed earlier, the number of players that are required to play such a combined for-money/free-to-play Class II game session may be evaluated based on, in some cases, the combined total of players waiting to play the for-money Class II game and players waiting to play the free-to-play Class II game. In other implementations, however, the number of players that are required to start such a combined for-money/free-to-play Class II game session may be evaluated solely on the basis of the number of players waiting to play the for-money Class II game.

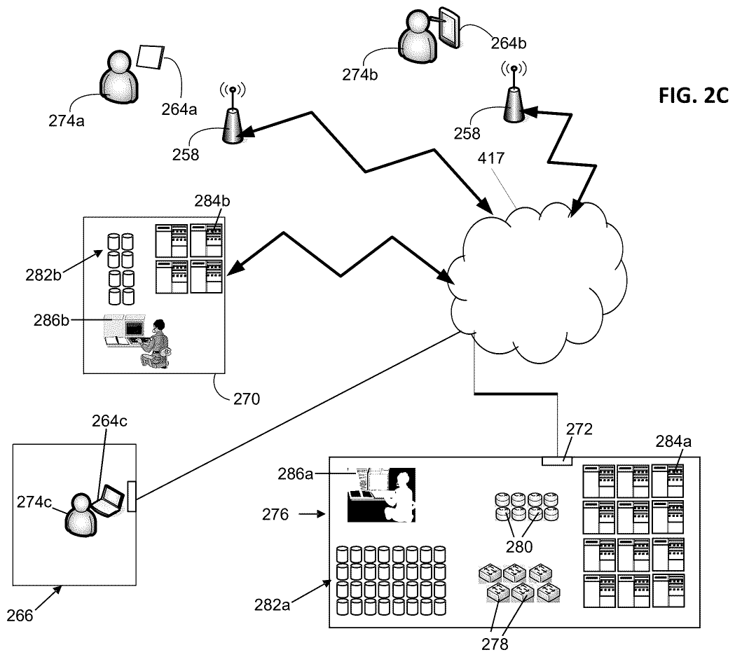

FIG. 4 depicts a schematic of an example architecture for providing mixed for-money/free-to-play Class II gaming experiences. As can be seen, the architecture includes a server 402 that is configured to randomly select numbers from a set of numbers, e.g., using a random number generator (either hardware-or software-based) for a Class II gaming session and then transmit data indicating the selected numbers to a plurality of devices 404 that are participating in that Class II gaming session. The devices 404, in this example, include devices 404a in a first subset of the devices and devices 404b in a second subsets of the devices. The server 402 may be further configured to perform such actions for multiple separate Class II gaming sessions simultaneously, e.g., the server 402 may store and track addresses, e.g., Internet protocol addresses for each device 404 participating in a particular Class II gaming session along with a unique identifier identifying the relevant Class II gaming session. The server may also track number selection information for each such Class II gaming session, e.g., the numbers that constitute the set of numbers from which numbers for the Class II gaming session are drawn or selected, the numbers in the set of numbers for each Class II gaming session that have been selected previously, how many numbers from each set of numbers have been selected thus far, etc. When the server selects a number for a given Class II gaming session, it may retrieve the addresses for the devices 404 that are participating in that Class II gaming session and then transmit information regarding that selected number (or numbers, if multiple numbers are selected in a group) to only the devices 404 that are participating in that Class II gaming session. In FIG. 4, for example, the server 402 is shown randomly selecting a number, e.g., the number 16 in this case, from a set of numbers (a portion of which is shown). The depicted number selection is shown, for purposes of analogy, as the selection of a ball with the number 16 from a plurality of other balls having other numbers on them, e.g., similar to the ball draw of a traditional game of bingo. The selected number is then transmitted to each of the devices 404a and 404b.

The devices 404 are, as noted above, divided into a first subset of devices 404a and a second subset of devices 404b. The allocation of each device 404 between the first subset of devices 404a and the second subset of devices 404b may be based on whether the player using the device 404 has indicated a desired to play the for-money version of a Class II game or the play-for-free version thereof. If the former, then the device 404 may be assigned to the first subset of devices 404a. If the latter, then the device 404 may be assigned to the second subset of devices 404b. It will be understood that in some instances, a particular device 404 may only be able to be assigned to one or the other of the subsets, e.g., some devices 404 may only be able to participate in for-money Class II game play and may thus always be in the first subset of devices 404a, while other devices 404 may only be able to participate in free-to-play Class II game play. The devices 404 may, for example, be traditional electronic gaming machines, e.g., gaming machines on a casino floor, or, if supported, mobile devices, such as smartphones, that belong to players.

Each of the devices 404 may also be in a communication with a player tracking server or other system that may be configured to identify players, track player winnings, facilitate transfers of funds from player accounts to the devices 404, track and manage rewards obtained during Class II game play, and/or track the number of free-to-play Class II game plays the player has obtained or made use of in one or more time periods. The player tracking server or other system may, for example, be part of the server 402 or may be provided via one or more other systems or servers. Such functionality may, in some cases, be distributed between multiple separate servers that are in communication with one another, either directly or indirectly.

For devices 404 that offer the ability for a player to participate in either for-money or free-to-play Class II gameplay, the device 404 may provide a GUI that allows the player to select between the two modes of Class II play. Presentation of such an interface may be contingent on the player being eligible to engage in free-to-play Class II games at the time the GUI is presented. For example, the device 404 may obtain information identifying the player and may send such identification information to the player tracking server along with a request for the player tracking server to indicate whether the player is eligible to play the free-to-play Class II game. If the player tracking server sends back a message that the payer is not eligible to play the free-to-play Class II game, then the GUI may be caused to not provide an interface that permits such play and to only enable options that allow the player to play the for-money Class II game. In other implementations, e.g., ones in which additional plays of the free-to-play Class II game beyond the initial free plays for a given time period may be obtained in exchange for a voucher or similar item, the GUI of the device 404 may be configured to provide additional GUI elements that may allow the player to provide such a voucher or equivalent. If the player selects to play the free-to-play Class II game option via the GUI of a device 404, then the device 404 may be placed in the second subset of devices 404b. In contrast, if the player elects to play the for-money Class II game, then the device 404 of the player may be placed in the first subset of devices 404a.

In some implementations, an electronic gaming machine may be configured to present a GUI that allows a player to play in the Class II game session in both free-to-play and for-money contexts. For example, the GUI may present two separate game-play regions, with one region displaying a bingo card or bingo cards for use in for-money play in a Class II game session, and the other region displaying a bingo card or bingo cards for use in free-to-play context play in the same (or a different) Class II game session.

The server 402 may track, for example, the number of players that have requested to play a Class II game and that have not yet been placed into an active Class II game session. When the number of such players reaches a predetermined level, the server 402 may initialize a combined for-money/free-to-play Class II game for those players, e.g., by sending messages to the devices 404 for the waiting players that instruct the devices 404 that a Class II game has been initiated and that the device 404 is a participant therein.

Each device 404 may be provided with one or more bingo cards for the combined for-money/free-to-play Class II game session. The bingo cards may be provided either in advance of the start of the combined for-money/free-to-play Class II game session or as part of the initialization or start of the for-money/free-to-play Class II game session once the predetermined number of players has been obtained. The bingo cards may be randomly generated or may have been pre-provided to one or more of the players. In some instances, a player may be provided with a GUI that is configured to allow the player to select between a plurality of different bingo cards. The bingo cards that are provided to players may generally be randomly selected, or selected from groups of bingo cards that have been randomly selected (e.g., to reduce the chances that two or more players will have the same or nearly the same bingo cards within a given Class II game session).

As discussed earlier, the bingo cards in the implementations discussed herein may be virtual or digital bingo cards, e.g., data constructs such as arrays that store numbers selected from a set of numbers in various array locations. Generally speaking, within a particular Class II game session, each bingo card used in that Class II game session will have the same number of array locations. The numbers that are stored in each of the array locations for a given bingo card used in that Class II game session will generally be selected from a single set of numbers that is associated with that Class II game session. It will generally be the case that when numbers are selected from the set of numbers and assigned to the array locations for a particular bingo card, such selections are made without replacement, i.e., the selected number is removed from the set of numbers before the next number is selected and assigned to another array location for the bingo card—although the set of numbers is reset to include the entire set of numbers after all of the array locations for a given bingo card that require number assignments have been assigned numbers.

For free-to-play Class II games, players may, for example, be provided with one or more bingo cards that are for use in a free-to-play Class II game, for example, two, four, six, eight, or ten bingo cards. In some implementations, the player may be required to play all of the provided bingo cards in simultaneously in a given free-to-play Class II game session, whereas in other implementations, the player may be required to play each provided free-to-play bingo card in a separate free-to-play Class II game session. In yet other implementations, the player may be given the option to play as many or as few of the provided free-to-play bingo cards as they like during a particular free-to-play Class II game session (subject, for example, to potential limits on the maximum number of bingo cards that may be able to be displayed or supported via the Class II game GUI). In some such implementations, the number of free-to-play bingo cards provided to a player during a given time period may, in effect, serve as a limit on the number of free-to-play Class II game play opportunities that the player will have within that time period. For example, a player may be provided with a daily allocation of a predetermined number, e.g., six, free-to-play bingo cards; the player may choose to use those free-to-play bingo cards in a single free-to-play Class II game session during that day or may choose to use the free-to-play bingo cards in multiple free-to-play Class II game sessions during the day (up to the number of free-to-play bingo cards that the player is provided with each time period), with each bingo card being ineligible for re-use in a free-to-play Class II game session during the day once used in an earlier free-to-play Class II game session by the player. In this example, the player may thus participate in a maximum of six free-to-play Class II game sessions throughout the day by using only a single free-to-play bingo card in each free-to-play Class II game session. On the following day, the player may receive a further six bingo cards for use in free-to-play Class II game sessions, and so forth. At the end of the given time period, any bingo cards that have not been used by the player in a free-to-play Class II game session may be disassociated from the player, e.g., not available for the player to use in a free-to-play Class II game session.

As noted earlier, a typical bingo card may include a 5×5 array of numbers, with the array locations in each row of array positions being populated with numbers drawn from the ranges of numbers 1-15, 16-30, 31-45, 46-60, and 61-75, respectively and without replacement. As also noted earlier, in some instances, one or more array positions of a bingo card may be designated as “wild” positions and may not have a number selected therefor; such positions may be treated as equivalent to any potentially drawn number. It will be understood that while Class II games typically use a two-dimensional array for the bingo cards used therein, bingo cards may also be represented by three-, four-, and higher-dimensional arrays—although such higher-order bingo cards may be difficult for players to interpret and may make the process of determining if a winning bingo pattern has been obtained quite challenging (to players). As a result, Class II games typically use two-dimensional bingo cards—it will be understood, however, that the principles discussed herein may also be used in other formats of Class II games, such as those that may employe such higher-order bingo cards. It will also be understood that bingo cards used in Class II game sessions may be represented by arrays having dimensions other than 5×5, e.g., 4×4, 3×3, 6×6, 4×5, 3×6, etc.

Once the server 402 has initiated a Class II game session and the players participating in the Class II game session for either for-money Class II game play or free-to-play Class II game play have received (or selected) the bingo cards that they will be using during the Class II game session, the server 402 may initiate the process of selecting numbers from the set of numbers used to populate the bingo cards.

In some instances, the server 402 may select an initial quantity of numbers as a batch, e.g., all at once or sequentially, and then distribute information indicating the selected numbers to all of the devices 404. Each device 404 may then evaluate the bingo card(s) being used by the player of that device 404 in view of the numbers selected by the server 402 from the set of numbers and determine if the array locations that correspond to the selected numbers (if any) for any of the bingo cards form any of the eligible bingo patterns for that player.

An eligible bingo pattern for a player is a bingo pattern which that player is allowed to claim if completed on a bingo card belonging to that player during a Class II game session and which will, if claimed by the player, cause the player to be provided with or associated with a reward of some type. In some instances, the act of claiming a completed eligible bingo pattern may be caused to be performed automatically for some or all players of a Class II game session, while in other instances, such a claim must be deliberately made by some or all players of a Class II game session. In some implementations, for example, Class II game systems may cause completed eligible bingo patterns for players participating in a Class II game session in a for-money context to be automatically claimed once they are obtained by a player, while at the same time requiring completed eligible bingo patterns for players participating in the Class II game session in a free-to-play context to be affirmatively claimed by such players in order for those players to be associated with, or provided, the award(s) for those completed eligible bingo patterns. In instances where completed eligible bingo patterns are automatically claimed, the Class II game may be configured to, for example, highlight the completed eligible bingo pattern in order to inform the player that has obtained the pattern of the completed eligible bingo pattern and then, without any action on the part of the player, cause the award associated with that completed eligible bingo pattern to be associated with that player.

A player may claim an eligible bingo pattern when the array positions on the player's bingo card or on one of the player's bingo cards that store numbers that have also been selected by the server 402 from the set of numbers correspond with designated array positions in the eligible bingo pattern.

In some implementations, the act of claiming an eligible bingo pattern may be limited for players of the free-to-play Class II game. For example, a player playing a free-to-play Class II game may be limited to claiming an eligible bingo pattern only once per Class II game session or, in some instances, per the same time period within which their total number of Class II game sessions and/or bingo cards may be usable (despite having multiple eligible bingo patterns available). For example, if a player is limited to playing a total of six free-to-play bingo cards per 24 hour period (starting at midnight each day), the player may also be limited to claiming only X eligible bingo patterns across one or all of the free-to-play Class II game sessions that the player may participate in within that 24 hour period. The value X may, in some cases, be as low as one, but may, in some instances, be 2, 3, 4, 5, 6, 7, 8, 9, 10, etc. In some instances, such limitations may be confined to a particular Class II game, e.g., one Class II game offering free-to-play Class II game sessions may have one limit on the number of free-to-play Class II game sessions that a player may participate in, while another Class II game offering free-to-play Class II game sessions may have a different limit on the number of free-to-play Class II game sessions that the player may participate in-in such implementations, the number of times that the player participates in the first Class II game in a free-to-play context within a given time period may be tracked separately from the number of times that the player participates in the other Class II game in a free-to-play context.

In implementations where a player is provided with the ability to affirmatively choose whether to claim a completed eligible bingo pattern, if an eligible bingo pattern is completed for a bingo card based on the selected numbers provided by the server 402, the device 404b that is presenting the Class II game GUI for that bingo card may cause the array positions that form the completed eligible bingo pattern to be displayed or highlighted on the bingo card and, optionally, to indicate what the name of the eligible bingo pattern is and/or what prize(s) may be associated with the completed eligible bingo pattern. The player of the free-to-play Class II game may then (assuming that the completed eligible bingo pattern needs to be affirmatively claimed instead of being automatically claimed) make a decision as to whether or not to claim the completed eligible bingo pattern, e.g., by causing a bingo claim indication to be generated by the player's device and then sent to, for example, the server that is administering or managing the Class II game session. For example, the GUI may be configured such that if the player touches the displayed or highlighted eligible bingo pattern on the bingo card, then the GUI presents a pop-up dialog asking if the player wishes to claim the eligible bingo pattern that was selected by the player. The pop-up may optionally display the eligible bingo pattern name and/or the reward(s) associated with that eligible bingo pattern. The pop-up may include touch inputs that include “yes” or “no” options to allow the player to instruct that the completed eligible bingo pattern be claimed, thereby causing the bingo claim indication to be generated and sent, or to proceed without claiming the eligible bingo pattern. Alternatively, the GUI may simply have a button labeled “call bingo” that may be selected by the player in order to claim the completed eligible bingo pattern (if multiple such eligible bingo patterns are present at one time, then the GUI may subsequently prompt the player to select a specific one (or ones) of the completed eligible bingo patterns). If the eligible bingo pattern is claimed, then the number (X) of eligible bingo patterns that the player may potentially be allowed to claim during the relevant time period, e.g., a 24-hour period, may be decremented by one. If the number (X) of eligible bingo patterns that the player may potentially be allowed to claim during the relevant time period was not reduced to zero as the result of a previous claim of a completed eligible bingo pattern within the time period, then the player may be caused to be provided with a prize that is associated with the claimed completed eligible bingo pattern. In some implementations in which a number of completed eligible bingo patterns are able to be claimed by a player, the GUI may also display, for example, the number of eligible bingo pattern claims that a player has remaining when displaying the interface options that allow for a completed eligible bingo pattern to be claimed.

As discussed earlier, some gaming systems allow players to participate in a Class II game session but present the bingo game results in the form of, for example, a slot machine outcome. For example, a player's bingo card may have a completed non-game-ending bingo pattern, and the gaming machine may show a particular slot machine outcome, e.g., a sequence of winning symbols along a payline, that results in a payout that is equivalent to the prize associated with the completed non-game-ending bingo pattern. It will be understood that in such contexts, “claiming” a bingo pattern is inclusive of the player claiming (or selecting for the purposes of claiming) the equivalent slot machine outcome. For example, the player may be presented with the slot machine outcome and asked if they wish to keep it/collect it (or the prize associated therewith). If the player opts to keep the slot machine outcome, this is equivalent to the player claiming the completed bingo pattern associated therewith. If the player opts to forego the slot machine outcome, this is equivalent to the player not claiming the completed bingo pattern associated therewith. In the event that a player has multiple completed eligible bingo patterns after a number selection, such a gaming machine may present multiple slot machine outcomes, e.g., multiple different winning patterns, each along different payline and each corresponding to one of the completed bingo patterns. In some such implementations, each winning pattern may be separately selectable by the player, thereby allowing the player to select none, some, or all of the winning patterns (subject to whatever limits may be present on the total number of winning patterns that the player may select) in order to claim the associated bingo patterns.

Such implementations may introduce an element of strategy to the free-to-play Class II game. For example, if a player knows that they have the ability to claim only one eligible bingo pattern per 24-hour period, then they may wish to hold off on immediately claiming an eligible bingo pattern that they complete during a Class II game session in the hopes that they may complete an additional eligible bingo pattern that may be associated with a more valuable prize than the initially completed eligible bingo pattern. In some implementations, however, there may be risks to such a strategy. For example, in some implementations, there may be a limited number of prizes associated with each eligible bingo pattern, e.g., one prize per different eligible bingo pattern. A player who waits to claim the prize for a particular completed eligible bingo pattern in the hopes of completing an eligible bingo pattern associated with a more valuable prize may lose out on the ability to later claim the prize for the initially completed eligible bingo pattern if another player also completes the same eligible bingo pattern and then claims it before the player that first completed that eligible bingo pattern. If that happens and the player that first completed that eligible bingo pattern is not able to complete a further eligible bingo pattern before the end of the Class II game session, then that player may miss out on obtaining a prize during that Class II game session. However, in other implementations, there may not be any limit on the number of prizes that are available to free-to-play players that complete a particular eligible bingo pattern associated with those prizes within a given Class II game session. In such implementations, a free-to-play player that chooses to wait to claim a completed eligible non-game-ending bingo pattern does not risk potentially losing the prize associated therewith to another player, but will, as discussed below, still be at risk of losing out on the ability to claim any prize if a game-ending pattern is claimed before the player opts to claim the completed eligible non-game-ending bingo pattern. In some implementations, there may be different tiers of the same prize that is associated with a particular eligible bingo pattern and different numbers of that prize for each tier. For example, in some implementations, there may be an eligible bingo pattern that is associated a prize of a ticket or tickets to a particular concert. However, there may be multiple tiers of such tickets, e.g., two front-row seat tickets, two general seating tickets, and one general seating ticket. There may be only one instance of the first tier prize (two front-row seat tickets) and two instances of the second tier prize (two general seating tickets), but there may be no limit on the number of third tier prizes (one general seating ticket), or perhaps a much larger limit, e.g., 20, on the number of third-tier prizes that may be won in association with claiming a completed bingo pattern associated with such prizes.

In implementations where a game-ending eligible pattern is obtained, e.g., by players that are playing the for-money Class II game (or, in systems that permit it, by a player participating in a for-money context or in a free-to-play context), the Class II game session may end for all players (free-to-play or for-money) in the Class II game session without further play in that Class II game session. In such instances, players of the free-to-play aspect of the Class II game session that have not yet claimed a completed eligible bingo pattern may be prevented from doing so. In some implementations, when a game-ending (or any) eligible bingo pattern is claimed, there may not be an immediate notification to other players that this has occurred. For example, the server 402 may be configured to select a number from the set of numbers, communicate information regarding the selected number to all of the devices participating in the relevant Class II game session, then wait for a predetermined period of time to allow bingo cards on the devices 404 to be updated and for players to claim any completed eligible bingo patterns that they wish to claim, and then, after the predetermined period of time elapses, cause at least the devices of the players that are to be provided prizes to display information regarding those prizes and/or the completed eligible bingo patterns for those prizes. In such an implementation, the ability to claim a completed eligible bingo pattern for a given number selection event may be terminated once the predetermined period of time for claiming completed eligible bingo patterns has elapsed—this makes it so that the players with unclaimed completed eligible bingo patterns must decide if they wish to claim such unclaimed completed eligible bingo patterns before knowing if other players are claiming the same completed eligible bingo pattern at the same time or if a player will have claimed the completion of a game-ending eligible bingo pattern, thereby ending the Class II game session.

It is to be understood that in the context of this disclosure, a “claim” that an eligible bingo pattern has been formed on a bingo card by virtue of the locations of numbers on the bingo card that match the numbers selected by the server forming an eligible bingo pattern only includes claims that are “valid” claims, i.e., where such a matching pattern has actually been formed. It will be understood that in some implementations, players may be able to attempt to claim a bingo even if none of the eligible bingo patterns for that player have been formed on any of the bingo cards associated with that player. In such implementations, it will be understood for the purposes of this disclosure that even if the player attempts to claim such a bingo, an actual “claim” has not been made by the player because it is not a valid claim. In some implementations, a premature or false bingo “claim” may have no negative effects-it may simply not result in the award of a prize to the player making such a claim, but the player may continue to participate in the free-to-play Class II game session as if the premature or false bingo claim had not been made. In other implementations, however, a premature or false bingo claim may be treated in the same manner as a valid bingo claim except that the player that makes the false or premature bingo claim is not provided or associated with a prize or award. If the players of the free-to-play Class II game session are subject to a limit on the number of bingo claims they may make within a given time period, for example, a false or premature bingo claim by such a player may be counted towards that limit in the same manner as a bingo claim that actually results in an award being provided to the player.

In some instances, the number of bingo pattern claims that a player playing in a free-to-play context may be allowed to make during the Class II game session may not be capped at all, but the duration of the player's participation in the Class II game session may instead be capped, e.g., to a limited number of number selections for the Class II game session. For example, a player participating in a Class II game session in a free-to-play context may be limited to only being allowed to claim non-game-ending patterns for no more than X number selections. For example, if X is 46, then such a player would be able to claim a non-game-ending pattern for the first 46 number selections but would not be permitted to claim any non-game-ending patterns for number selections 47 onwards. In a Class II game session in which there are 75 numbers in the set of numbers from which numbers are selected and in which the first 40 number selections occur as a group, this would mean that such a player of the second type would only have six new number selections after the initial number selection in which to complete a non-game-ending pattern. Put another way, the systems providing the Class II game session may be configured to cease providing promotional awards to players of the second type after a first quantity X of numbers have been selected, e.g., by a server, from the set of numbers for the Class II game session and before a second quantity X+1 of numbers has been selected (or, alternatively, after the X+1 number selection but before players participating in the Class II game session have been informed of the number for the X+1 number selection). Such a system may either allow such players to continue playing and making bingo claims but not provide any associated rewards, or may simply prevent such players from participating in the Class II game session entirely (at least, until such limits are reset, e.g., at the start of a new day or other time interval). In some instances in which there may be limits on the number of number selections for a Class II game session that each player of the second type of player may be able to participate in, such a limit may be greater than or equal to 45 but less than or equal to 50, or greater than or equal to 45 but less than or equal to 47, or, for example, equal to 46.

Such a mechanism may be a further way of limiting players' ability to obtain winnings in a free-to-play context. In some instances, a player playing in a free-to-play context may have both the number of number selections that they may play for in a given Class II game session and the number of bingo claims that they may make during that session be capped or limited at associated threshold values.

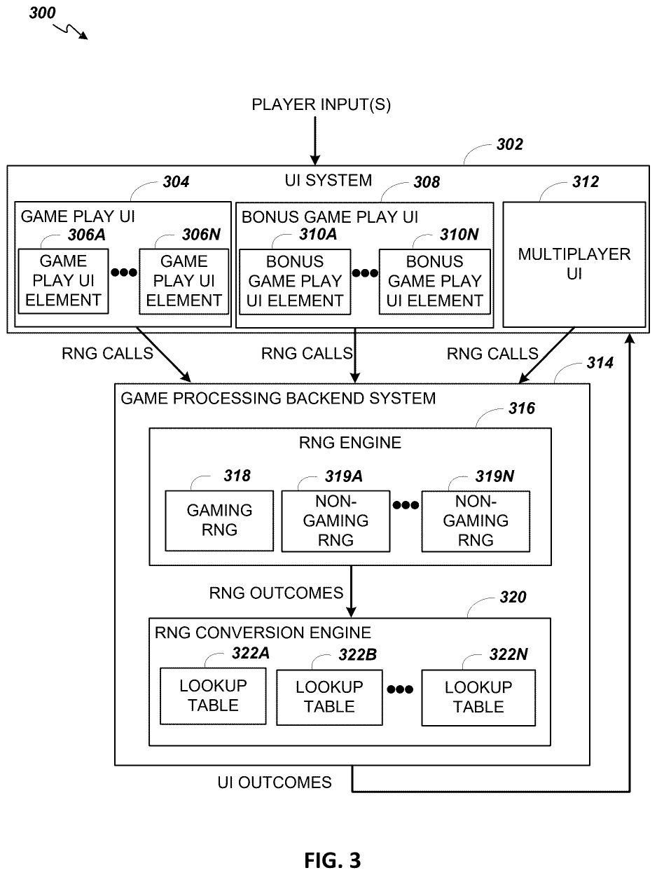

FIG. 5 depicts a flow diagram for one technique for offering a free-to-play Class II game session that avoids or minimizes issues with delayed start times associated with such a game that may arise due to limitations on the number of free-to-play Class II game sessions that each player thereof may be eligible to participate in within a given time period.

The technique of FIG. 5 may start in block 502, in which the system that provides a Class II game session may receive requests from players wishing to join the Class II game session. Such requests may be received from devices of a first type or a second type. The devices of the first type may, for example, be devices used by players wishing to participate in the Class II game session in a for-money context, while the devices of the second type may be devices used by players wishing to participate in the Class II game session in a free-to-play context. A device of the first type may, it will be understood, be able to become a device of the second type depending on selections made by a player using that device (and vice versa).

In block 504, a determination may be made as to whether the number of players that are waiting to participate in the Class II game session has reached a first threshold amount. As noted earlier, a Class II game session requires two players in order to start, but the nature of those players in the context of a for-money/free-to-play Class II game session may vary depending on how the game session is configured—for example, two players that are participating in the context of for-money play may be required in some cases (regardless of how many players in the free-to-play context may be waiting), while in other cases, as discussed earlier, any two players may be sufficient-regardless of whether they are participating in a for-money context or a free-to-play context.

For example, a server administering a Class II game session may be configured to start the Class II game session immediately after sufficient players are waiting for the Class II game session to start. Alternatively, the server may check over various intervals to see if the requisite number of players waiting to participate in that Class II game session has been reached—if not, then the server may wait a further period of time and then check again. In such an implementation, the Class II game session will only start once a minimum number of participants are waiting to play but may also have more than the minimum number of participants, e.g., additional players that queue up to play after the minimum number of participants are waiting to play but before the server next evaluates the queue. In some instances, the determination of whether the minimum number of participants has been reached may be superseded by an overall time limit being reached. For example, the server may wait until a minimum number of players is queued up to participate in the Class II game session or until a predetermined time limit has been reached, whichever occurs first.

If it is determined in block 504 that the requisite number of players waiting to participate in the Class II game session has not been reached, then the technique may return to block 502 to allow further players to queue up to participate in the Class II game session, e.g., by sending requests to join the Class II game session to the server.

If it is determined in block 504 that the requisite number of players waiting to play in the Class II game session has been reached, then the technique may proceed to block 506, in which the Class II game session may be initiated. As part of starting the session (or in advance of starting the session), each device that is participating in the Class II game session may be associated with one or more bingo cards and with a set of one or more eligible bingo patterns. The technique may then proceed to block 508, in which an initial selection of one or more numbers may be made from the set of numbers that were used to populate the bingo cards that were associated with the devices in block 506 (or earlier). Such a selection may, for example, be made by a central server, e.g., a bingo server, that is specially configured to make such random selections. In some implementations, for example, 40 numbers may be selected in block 508 out of a set of 75 numbers (with each bingo card being randomly populated with 25 numbers selected from the range of 1 to 75, for example). Information regarding the initially selected number or numbers may then be distributed to the devices participating in the Class II game session in block 510. The GUIs of the devices may, for example, be caused to update depictions of the bingo card(s) associated with each device that show the positions on those bingo card(s) that have numbers corresponding to any of the initially selected numbers marked in some way to indicate that those positions have been, in the parlance of bingo, “daubed.” The numbers in the set of numbers are non-repeating and selections of numbers from the set of numbers is performed without replacement, i.e., once a number from the set of numbers is selected, it is removed from the set of numbers and cannot be selected again. The selections of numbers from the set of numbers are performed randomly.

It will be understood that it is possible for players to join the Class II game session after it has started. Such players may be caused to “catch up” to the players that are already participating in the Class II game session, e.g., by presenting the numbers selected thus far to the newly joining players in an accelerated fashion as compared with how the selected numbers are presented to the existing players. This may continue until the newly joined players have been provided with all of the numbers that have been selected thus far. For example, in a given Class II game session, there may be approximately 2 seconds in between each number selection after the initial number selection has concluded. A player joining such a Class II game session 11 seconds after it starts may be provided with the numbers selected in the initial number selection immediately upon joining the Class II game session and may then be provided with the additional numbers subsequently selected being presented at a rate that results in approximately 1 second in between numbers. In such an implementation, the later-joining player may catch up to the existing players after approximately 12 seconds, when both the existing players and the later-joining player will have been presented with a total of 51 selected numbers.

In some implementations, players joining a Class II game session after it has already started may be “caught up” immediately, e.g., by providing such players with all of the numbers that have been selected thus far in the game session all at once. In such implementations, such players may be provided with a bingo card that is either pre-daubed (marked) to indicate the numbers selected thus far in the Class II game session or that is marked in near-instantaneous fashion immediately after the player joins the Class II game session.

In some further implementations, players that join a Class II game session after the Class II game session has already started may be “caught up” with the number selection in different ways depending on the context in which they are participating in the Class II game session. For example, players that join an already in-progress Class II game session in a for-money context may be caught up immediately after joining, e.g., they may immediately be informed of all of the number selections made thus far in the Class II game session and have their bingo cards marked or daubed accordingly. In contrast, players that join the already in-progress Class II game session in a free-to-play context may be caught up with all of the number selections made thus far in the Class II game session in a non-instantaneous but still accelerated fashion, as discussed earlier above. Such an approach may allow players participating in the Class II game session in a free-to-play context the ability to still experience each number selection after the initial number selection as a discrete event. Such an implementation may provide time for the free-to-play context player to make a decision as to whether or not to claim a particular completed non-game-ending pattern in implementations in which such a player may be subject to a limit on the number of non-game-ending pattern claims made.

The technique may then proceed to block 512. In block 512, a determination may be made as to whether an eligible game-ending pattern has been obtained on any of the devices, i.e., has a valid claim been made that all or some of the numbers that have been selected thus far in the Class II game session correspond with numbers in locations on a bingo card associated with such a device that form the eligible game-ending pattern? For example, if the eligible game-ending pattern is a “blackout” pattern (i.e., each of the array positions in a bingo card is either a “wild” position that is treated as “daubed” without regard to the numbers actually selected or is assigned a number corresponding to one of the numbers selected from the set of numbers for the game session) and one of the bingo cards for one of the devices has numbers that correspond to the selected numbers such that every array position in that bingo card is either a wild position or has a number that matches one of the selected numbers, then that eligible bingo pattern may be claimed by the player of that device.

For the purposes of this disclosure, reference to a “bingo pattern” is to be understood to include only bingo patterns that, when claimed, do not end a bingo game, while reference to “game-ending pattern” is to be understood to refer to a pattern that, when claimed, does end the bingo game. Technically, a game-ending pattern may be considered to be a particular type of bingo pattern, but for the purposes of this disclosure, a “game-ending” pattern is to be viewed as separate from “bingo patterns.”

The term “eligible” is used in reference to bingo patterns and game-ending patterns in this disclosure since the patterns that may be claimed by players with respect to the patterns that selected numbers may, in effect, make on their bingo cards may be limited to particular bingo patterns and/or game-ending patterns. For example, with respect to game-ending patterns, the Class II game session may be configured such that only players playing on a device of the first type (those playing in a for-money context) may be allowed claim a game-ending pattern, while players playing on devices of the second type may be prohibited from claiming any game-ending pattern(s). Moreover, there may be different sets of bingo patterns that different players may be eligible to claim, as will be discussed later in more detail—thus, the eligible bingo patterns for one group of players of the second type in a Class II game session might be different from the eligible bingo patterns for another group of players of the second type within that same game session. Additionally, it may be the case that in some implementations, the bingo patterns that a player is eligible to complete may not only depend on the context in which the player is participating in the Class II game session (for-money v. free-to-play), but may also depend on the current state of the Class II game session, e.g., some bingo patterns may only become “eligible” bingo patterns for some players after a certain quantity of numbers have been selected for the Class II game session. For example, as discussed earlier, in implementations in which a free-to-play context player may be able to claim a game-ending pattern, the game-ending pattern may only be an “eligible” bingo pattern for that player after a predetermined quantity of numbers have been selected for the Class II game session, e.g., after 73, 74, or 75 numbers out of 75 total numbers have been selected.

Moreover, it will be understood that, as discussed earlier, completed bingo pattern claims may, in some cases, be made automatically by the devices associated with bingo cards where such bingo patterns are completed, whereas in other cases, such claims may need to be affirmatively or explicitly initiated by the players of such devices. It will also be understood that in some instances, players participating in the same Class II game session in different contexts may have different completed bingo pattern claiming requirements, e.g., devices used by players participating in the Class II game session in a for-money context may automatically claim completed bingo patterns, while devices used by players participating in the Class II game session in a free-to-play context may require that such players affirmatively or explicitly initiate a claim to a completed bingo pattern.

If it is determined in block 512 that a game-ending pattern has been claimed by a device for the Class II game session, then the technique may proceed to block 514, in which the Class II game session may be caused to end for all of the devices participating in the Class II game session.

In some instances, a game-end award may be associated with the player that was using the device that claimed the game-ending pattern. For example, in implementations in which the game-ending pattern can only be claimed by a player using a device of the first type, i.e., a player participating in the Class II game session in a for-money context, the game-end award may be a monetary amount or an amount of credits or other tokens that are exchangeable for a monetary amount.

If it is determined in block 512 that a game-ending pattern has not been claimed by a device for the Class II game session, the technique may proceed to blocks 516 and 518 in parallel. In block 516, the system may cause Class II game play to be conducted for devices of the first type according to the conventions governing how the Class II game play occurs for players participating in the Class II game session in a for-money context. For example, players that are participating in the Class II game session in a for-money context may have completed bingo patterns automatically claimed and may all be able to claim completed bingo patterns from the same set of eligible bingo patterns. In block 518, the system may cause Class II game play to be conducted for devices of the second type according to the conventions governing how the Class II game play occurs for players participating in the Class II game session in a free-to-play context. For example, players that are participating in the Class II game session in a free-to-play context may be required to affirmatively or explicitly initiate a claim to a completed bingo pattern. In another example, some players participating in the Class II game session in a free-to-play context may be assigned different sets of eligible bingo patterns that may limit which completed bingo patterns that each such player may be able to claim. As part of conducting such Class II game play, the system may, in some instances, cause awards to be associated with players that have claimed a completed eligible bingo pattern.

It will be understood that, in practice, references to a player in the technique above and in later discussion below may implicitly include reference to a player account, such as a player tracking account, that is associated with a player. For example, a particular device that is participating in a Class II game session may be associated with a player account belonging to a player that is using that device for the duration of the Class II game session, and awards that may be caused to be associated with the player may be associated with the player by associating them with the player's player account, e.g., causing a record to be generated that links an identifier associated with the award with an identifier that uniquely identifies the player account.

After Class II game play is conducted in blocks 516 and 518, the technique may proceed to block 520, in which an additional selection may be made of a number from the set of numbers that were used to populate the bingo cards that were associated with the devices in block 506 (or earlier). Such a selection may, for example, be made by the central server, e.g., the bingo server, that is specially configured to make such random selections. Information regarding the initially selected number or numbers may then be distributed to the devices participating in the Class II game session in block 522. The devices may then cause the GUIs of the devices to, for example, update depictions of the bingo card(s) associated with each device that show the positions on those bingo card(s) that have numbers corresponding to any of the initially selected numbers or the later-selected numbers marked in some way to indicate that those positions have been, in the parlance of bingo, “daubed.” The technique may then return to block 512 in order to re-perform blocks 512 through 522, taking into account the newly selected number(s), until it is determined in block 512 that a game-ending pattern is obtained.

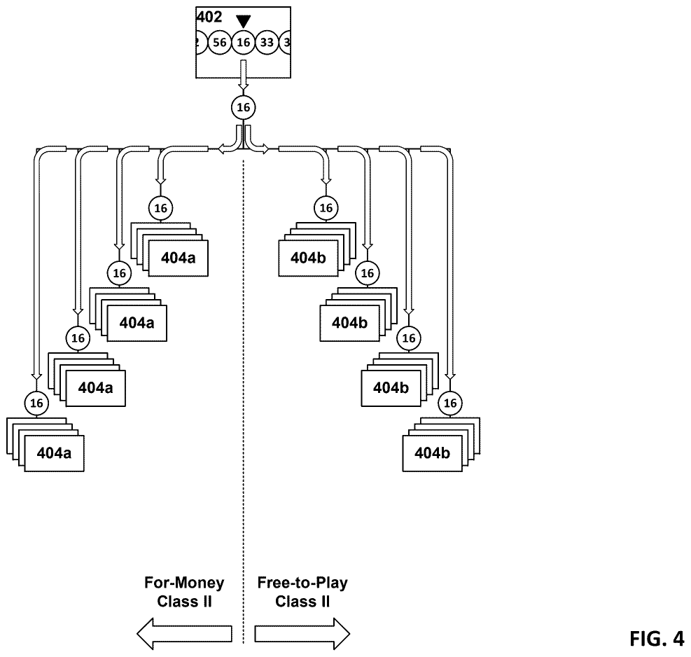

FIG. 6 depicts a flow diagram for another technique for offering a free-to-play Class II game session that avoids or minimizes issues with delayed start times associated with such a game that may arise due to limitations on the number of free-to-play Class II game sessions that each player thereof may be eligible to participate in within a given time period.

The technique of FIG. 6 is initially similar to that of FIG. 5 and may start in block 602, in which the system that provides a Class II game session may receive requests from players wishing to join the Class II game session. Such requests may be received from devices of a first type or a second type, as with the technique of FIG. 5.

In block 604, a determination may be made as to whether the number of players that are waiting to participate in the Class II game session has reached a first threshold amount.

If it is determined in block 604 that the requisite number of players waiting to participate in the Class II game session has not been reached, then the technique may return to block 602 to allow further players to queue up to participate in the Class II game session, e.g., by sending requests to join the Class II game session to the server.

If it is determined in block 604 that the requisite number of players waiting to play in the Class II game session has been reached, then the technique may proceed to block 606, in which the Class II game session may be initiated. As in the technique of FIG. 5, as part of starting the session (or in advance of starting the session), each device that is participating in the Class II game session may be associated with one or more bingo cards and with a set of one or more eligible bingo patterns. The technique may then proceed to block 608, in which an initial selection of one or more numbers may be made from the set of numbers that were used to populate the bingo cards that were associated with the devices in block 606 (or earlier). Information regarding the initially selected number or numbers may then be distributed to the devices participating in the Class II game session in block 610. The GUIs of the devices may, for example, be caused to update depictions of the bingo card(s) associated with each device, similar to the technique of FIG. 5.

The technique may then proceed to block 512. In block 512, a determination may be made as to whether an eligible game-ending pattern has been obtained on any of the devices If it is determined in block 512 that a game-ending pattern has been claimed by a device for the Class II game session, then the technique may proceed to block 514, in which a game-end award may be associated with the player that was using the device that claimed the game-ending pattern. The technique may then proceed to block 616, in which the Class II game session may be caused to end for all of the devices participating in the Class II game session.

If it is determined in block 612 that a game-ending pattern has not been claimed by a device for the Class II game session, the technique may proceed to blocks 616 and 624 in parallel. In block 616, the system may cause Class II game play to be conducted for devices of the first type according to the conventions governing how the Class II game play occurs for players participating in the Class II game session in a for-money context, similar to the technique of FIG. 5.

In blocks 624 through 628, the system may cause Class II game play to be conducted for devices of the second type according to the conventions governing how the Class II game play occurs for players participating in the Class II game session in a free-to-play context for this particular implementation.

For example, in block 620, a determination may be made as to whether a non-game-ending pattern has been claimed by a device of the second type. It will be understood that similar determinations may, in some instances, be made in block 618 with regard to devices of the first type. If it is determined in block 620 that a non-game-ending pattern has been claimed by a device of the second type, then the technique may proceed to block 622, in which an award associated with the claimed non-game-ending pattern may be associated with a player that is using the device of the second type that made the claim to non-game-ending pattern. The technique may then proceed to block 624, in which a further determination may be made as to whether the player of the device that made the claim to the non-game-ending pattern has reached a time-based pattern claim limit. For example, as discussed earlier, players that are playing in the Class II game session using a device of the second type may be limited in the number of completed patterns that they may be allowed to claim within a given time period while using a device of the second type. In some instances, the time period may be the duration of the Class II game session, e.g., the player may be limited in the number of completed patterns that they may claim during the Class II game session, but that limit may not impact the number of completed patterns that they may claim during a subsequent Class II game session. In other instances, the player may be limited in the number of completed patterns that they may claim during a time interval that is longer than the duration of the Class II game session, in which case a player reaching such a limit in a Class II game session would be precluded from claiming further completed patterns in subsequent Class II game sessions occurring within that time interval. If the time interval for the time-based pattern limit is longer than the duration of the Class II game session, then the determination of whether a player has reached the time-based pattern limit may be made by referencing data associated with a player account of the player; such data may thus be transferrable from Class II game session to Class II game session and still be associated with the relevant player. If the time interval for the time-based pattern limit is equal to the duration of the Class II game session, then the device itself (or a server) may simply track whether the number of completed patterns claimed by the player using the device in the current Class II game session exceeds the time-based pattern limit.

If it is determined in block 624 that the player of the device has not reached the time-based pattern limit, then the technique may proceed to block 626, where a pattern claim count for the player of the device may be updated, e.g., incremented by one, to reflect that the completed non-game-ending pattern was claimed. The pattern claim count may, for example, be referenced in block 624. If it is determined in block 624 that the player of the device has reached the time-based pattern limit, then the technique may proceed to block 626, where the player of the device may be caused to be made ineligible to win further awards within the associated time period of the time-based pattern limit. There may be multiple ways of accomplishing this. For example, the player may not be permitted to enter a further Class II game session using a device of the second type for the remainder of the time period and may be disallowed from claiming further completed patterns on the device of the second type that they are presently using for the remainder of the current Class II game session. In another example, the player may not be permitted to enter a further Class II game session using a device of the second type for the remainder of the time period but may continue to be allowed to claim further completed patterns on the device of the second type that they are presently using for the remainder of the current Class II game session, but may not be associated with any awards in response to such claims being made.

After block 618 and block 626 or 628 have completed, the technique may proceed to block 630, in which an additional selection may be made of a number from the set of numbers that were used to populate the bingo cards that were associated with the devices in block 606 (or earlier). As in the technique of FIG. HH, such a selection may, for example, be made by the central server, e.g., the bingo server, that is specially configured to make such random selections. Information regarding the initially selected number or numbers may then be distributed to the devices participating in the Class II game session in block 632. The devices may then cause the GUIs of the devices to, for example, update depictions of the bingo card(s) associated with each device that show the positions on those bingo card(s) that have numbers corresponding to any of the initially selected numbers or the later-selected numbers marked in some way to indicate that those positions have been, in the parlance of bingo, “daubed.” The technique may then return to block 612 in order to re-perform blocks 612 through 632, taking into account the newly selected number(s), until it is determined in block 612 that a game-ending pattern is obtained.

As discussed earlier, another technical issue that may arise in a Class II game session that incorporates a free-to-play aspect is the ability to provide different players with different play experiences depending on, for example, the relative value of each player. In free-to-play games where each player is playing independently of other players, e.g., in free-to-play Class III games, each game instance of a particular game may present exactly the same overall game play experience but may tune the probabilities of different outcomes on a player-by-player basis. For example, in a slot machine game played by multiple different players in a free-to-play context, the slot machine may provide each player with the same rewards for the same winning patterns, but may adjust the probability of any particular pattern occurring for a particular player by adjusting the weightings for the random outcome determination so that certain outcomes are more likely to occur than others. Such a technique allows the free-to-play game experience to be, at least visually, identical to the for-money game experience with the same game.

In a Class II game session, however, multiple players have game experiences that are determined by common random outcomes, e.g., the random number selections made by the server, and it is therefore not feasible to tune the randomness of the outcome determination to favor one groups of players in the Class II game session over another group of players. Due to the randomness of each player's bingo card in a Class II game session, any weighting of a number selection to pick one number over another will likely benefit some players of each such group and hurt some players of each such group, making it infeasible to adjust the game play experience of each group of players in a predictable manner by tuning the random selection probabilities for number selection. This is a technical issue that arises from the use of a single random determination system being used to drive the game play experience for multiple players within a single game session.

In particular, and as discussed earlier, if a free-to-play Class II game session involves players that are participating in a free-to-play context and a for-money context, it may be illegal to modify the probabilities of any particular number being selected since such number selections are applicable to both players engaged in free-to-play Class II game play and players engaged in for-money Class II game play.

As mentioned earlier, there are two distinct technical solutions that may be used to address this technical issue.

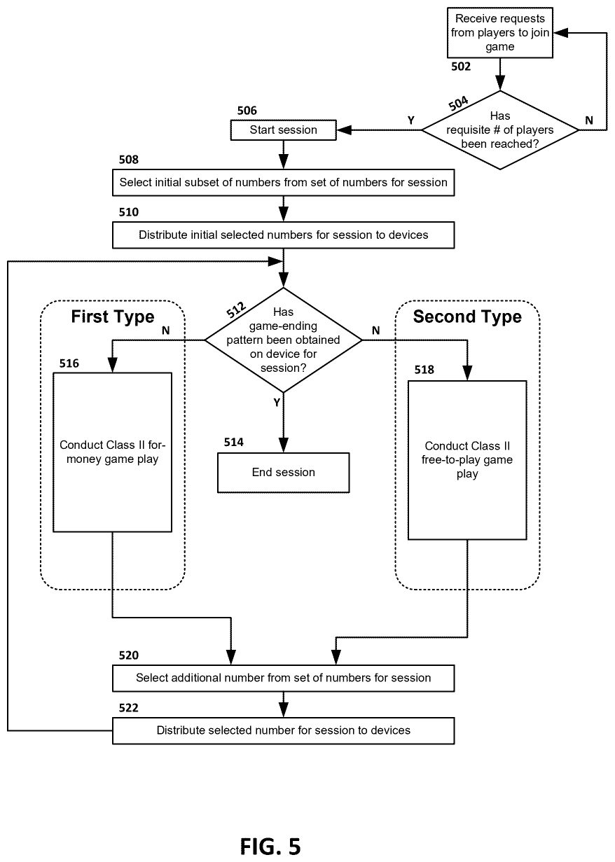

The first technical solution is provided by the technique illustrated in FIG. 7. In this technique, player identification information is obtained in block 702 for at least each player of the second type (e.g., a player participating in a Class II game session in a free-to-play context) that claims a non-game-ending pattern. In some instances, player identification information is obtained for all players of the second type in block 702. In block 704, a determination as to a value level may be made for each player for which the identification information was obtained; the value level may be determined based on the identification information for the player. For example, the identification information may be used to identify the player within a player tracking system that may track playing habits, spending habits, and the like for the player. Such a player tracking system may, for example, categorize players into various classifications based on various parameters. For example, players that engage in regular or extended play of for-money Class II games, or that wager larger sums in Class II games, may be classified as “high” value players, while players that engage in lesser a lower amount of Class II game play may be classified as “average” value or “low” value players, and players that almost never engage in for-money Class II game play may be classified as “undesirable” players. Such classifications may, in some instances, be stored in a player tracking system or other system in association with an identifier for the player and may potentially be updated periodically, e.g., according to a regular schedule or in response to various events or milestones occurring, such as the player engaging in a particular activity (such as playing a number of for-money Class II games). The above steps may, for example, be used to establish a value level that is associated with a player account for each player that is, at least for a given Class II game session, associated with the device being used by that player to participate in the Class II game session.

In block 706, a multiplier value may be determined for the player based on the value level for the player. The value levels may, for example, be ranked, e.g., the first value level may be the highest-ranked value level, with a second level ranked below the first value level, and a third level ranked below the second level, and so forth. The corresponding multiplier for each value level other than the first value level may be less than or equal to the corresponding multiplier for the value level ranked next-highest. The corresponding value level for the first value level may be greater than the corresponding multiplier or multipliers for one or more of the other value levels. For example, a high-value player may be assigned a 2× multiplier, an average-value player may be assigned a 1.2× multiplier, a low-value player may be assigned a 1.0× multiplier, and an undesirable-value player may be assigned a 0.1× multiplier (or even a OX multiplier). In block 708, each award provided to a player may be multiplied by the multiplier determined for that player prior to being awarded to the player. Such multiplying may occur before the player is made aware of the award, or may be performed after making the player aware of the award. In such a technique, the value of the awards won by players of various value levels may be adjusted to reflect their relative values, but such adjustment does not, in itself, alter the probabilities of any particular player obtaining a winning outcome.

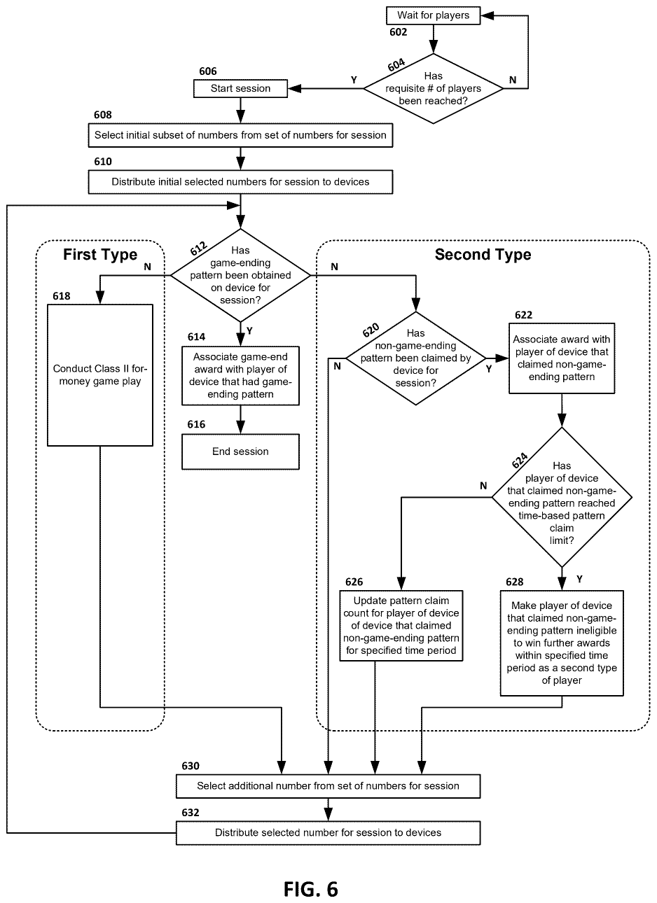

In the diagram of FIG. 8, however, a different technique is provided that allows player's probabilities of obtaining an award to be adjusted within the Class II game session. Blocks 802 and 804 in the technique of FIG. 8 are identical to blocks 702 and 704 in the technique of FIG. 7 and are not re-described here, except that each player of the second type may be identified and a value level therefore may be determined.

In the technique of FIG. 8, the technique proceeds to block 806 after determining value levels for each player. In block 806, a set of one or more eligible non-game-ending patterns is identified and assigned to each player. Each set of one or more eligible non-game-ending patterns assigned to each player may be selected based on the player's value level, and the sets of eligible non-game-ending patterns may be established such that the sets corresponding to different value levels are different in at least some respects.

Generally speaking, the average complexity of the non-game ending patterns in the sets for higher-valued players may be lower than the average complexity of the non-game-ending patterns in the sets for lower-valued players. The complexity of a non-game-ending pattern may be dependent, at least in part, on the number of array locations in a bingo card that must have numbers that match selected numbers from the set of numbers in order for the non-game-ending pattern to be formed. For example, a non-game-ending pattern that may be formed by only 3 array locations may be much easier to form than a non-game-ending pattern formed by 10 array locations. Thus, each player may be assigned a set of eligible non-game-ending patterns, i.e., the non-game-ending patterns that that player is eligible to (or allowed to) claim during the Class II game session. Each such set may have a corresponding average probability, based on the complexities of the non-game-ending patterns in the set, that one or more of the eligible non-game-ending patterns in the set will be formed on or with respect to a given bingo card after a particular number of numbers have been selected from the set of numbers.

The set of non-game-ending patterns assigned to each player may, in at least some instances, be displayed in block 808 to that player, e.g., on the GUI that shows the bingo card(s) that that player is playing in the Class II game session or in another GUI that may be accessible to the player, e.g., by pressing a button or control on the GUI. The device that such a player is using in the Class II game session may only permit the player of that device to claim non-game-ending patterns that are among the eligible non-game-ending patterns assigned to that player.

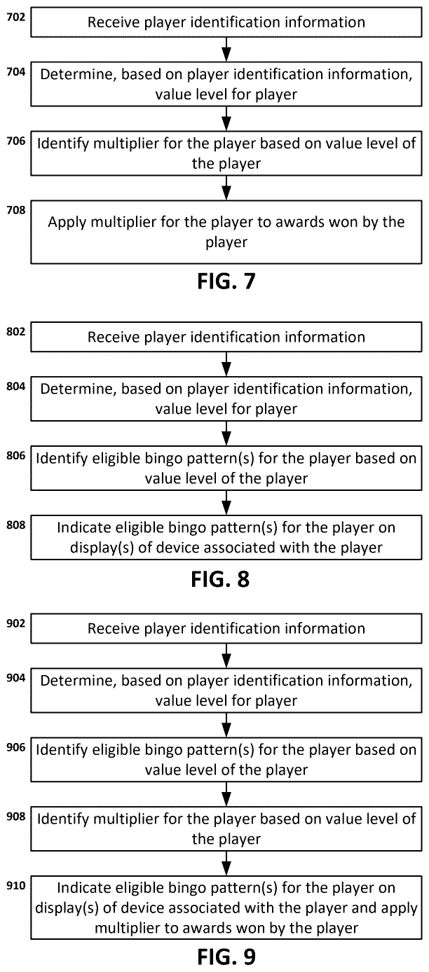

In some instances, the two techniques of FIGS. 7 and 8 may be combined, e.g., as shown in FIG. 9. As can be seen, the technique in blocks 902 to 910 of FIG. 9 combines the various blocks of FIGS. 7 and 8.

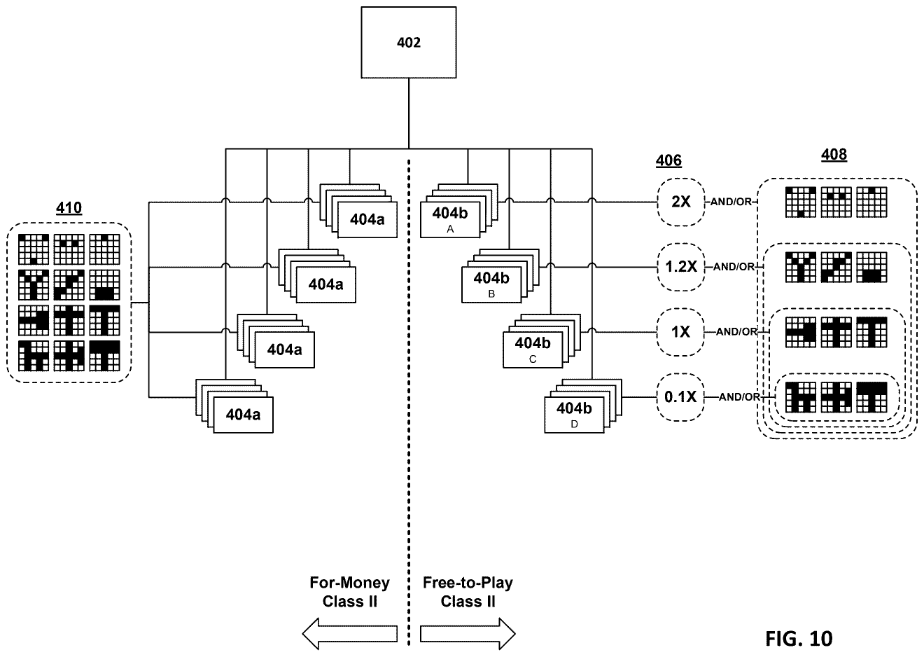

FIG. 10 depicts a schematic of a system, similar to that of FIG. 4, for providing a combined for-money/free-to-play Class II game experience. Players of the first type, which may all play on devices 404a, may all play with the same set of eligible non-game-ending patterns 410 (they may also play with the same set of one or more game-ending patterns, which are not shown), as represented by the twelve eligible non-game-ending patterns 410. In contrast, players of the second type, which may all play on devices 404b, may play with different sets of eligible non-game-ending patterns 408 and/or different multipliers 406 that have been assigned to such players based on value categorizations of the players. The players of the devices 404b(A), for example, may be players that are categorized as being “high” value players and may utilize a set of non-game-ending patterns 408 that is the same as the set of non-game-ending patterns 410 used by the players of the first type and/or benefit from a 2× multiplier that may be applied to any awards that they are provided during play of the Class II game session. Similarly, the players of the devices 404b(B), for example, may be players that are categorized as being “average” value players and may benefit from a 1.2× multiplier that may be applied to any awards that they are provided during play of the Class II game session and/or may utilize a set of non-game-ending patterns 408 that is the same as the set of non-game-ending patterns 408 used by the “high” value players of the second type but without the three easiest-to-attain non-game-ending patterns 408 (the three patterns with only three daubed array locations). The players of the devices 404b(C), for example, may be players that are categorized as being “low” value players and may benefit from a 1× multiplier that may be applied to any awards that they are provided during play of the Class II game session and/or may utilize a set of non-game-ending patterns 408 that is the same as the set of non-game-ending patterns 408 used by the “average” value players of the second type but without the three easiest-to-attain non-game-ending patterns 408 in that set (the three patterns with only six or seven daubed array locations). The players of the devices 404b(D), for example, may be players that are categorized as being “undesirable” value players and may benefit from a 0.1× multiplier that may be applied to any awards that they are provided during play of the Class II game session and/or may utilize a set of non-game-ending patterns 408 that is the same as the set of non-game-ending patterns 408 used by the “low” value players of the second type but without the three easiest-to-attain non-game-ending patterns 408 in that set (the three patterns with nine daubed array locations).

In the example of FIG. 4, the players that participate in the Class II game session as players of the second type in higher-valued categories are provided with eligible non-game-ending patterns that include all of the eligible non-game-ending patterns that are provided to players of the second type that are in lower-valued categories. However, in other implementations, two or more value categories of players of the second type may be provided with completely separate eligible non-game-ending patterns, e.g., with no overlap.

Another technique that may be employed in some instances to adjust the probability of one group of players, e.g., higher-value players, being able to claim a non-game-ending pattern to be higher than it is for another group of players, e.g., lower-value players, is to adjust the quantity of number selections for which each such player will be permitted to participate in the Class II game session. For example, as discussed earlier, in some implementations, players playing in a Class II game session in a free-to-play context may be capped in terms of the extent to which they can participate, e.g., to a limited number of number selections for the Class II game session. In such implementations, a further avenue for providing differentiating game play for differently valued players during such a Class II game session may be to allocate different caps for differently valued players. For example, players that are of a high value category may be permitted to participate in the Class II game session for X number selections, with players of an average value category being allowed to participate in the Class II game session for X-8 number selections, players of a low value category being allowed to participate in the Class II game session for X-16 number selections, and players of an undesirable category being allowed to participate in the Class II game session for X-24 number selections. In such an implementation, for example, X may be 70, such that the high-value players are allowed to claim eligible non-game-ending patterns for the first 70 number selections, while the average-value players are allowed to claim eligible non-game-ending patterns for the first 62 number selections, the low-value players are allowed to claim eligible non-game-ending patterns for the first 54 number selections, and undesirable-value players are allowed to claim eligible non-game-ending patterns for the first 46 number selections.

As discussed earlier with regard to implementations in which there may be a limited number of bingo pattern claims that a player may make while playing in a Class II game session in a free-to-play context, some implementations of for-money/free-to-play Class II games may provide different awards or rewards a bingo claim assertion for a given eligible bingo pattern depending on when in the Class II game session such a bingo claim is made. For example, each eligible non-game-ending pattern for use by a player playing in a Class II game session may be associated with a table that may define one or more awards that may be provided to the player to if the player makes a bingo claim for that non-game-ending pattern. Such a table may, for example, define different awards that may be provided to the player if the player makes a bingo claim to that non-game-ending pattern after X selections of a number from the set of numbers in the Class II game session as opposed to after Y selections of a number from the set of numbers in the Class II game session.

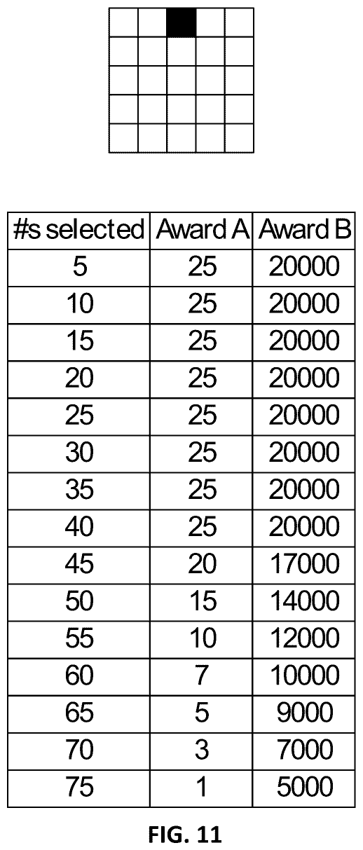

FIG. 11 depicts an example table for an example eligible non-game-ending pattern. The example table of FIG. 11 is associated with the eligible bingo pattern shown at top. A bingo claim may be made for such a pattern when one of the numbers selected thus far in the Class II game session matches the number in the middle top row position of a player's bingo card. As the table shows, there are two columns for awards—an award A column and an award B column. In this example, the award A is a number of free plays or free spins that may be used in another game by the player, e.g., during monetary play of that other game. The award B, however, is a number of player loyalty or tracking points, e.g., that may be added to unredeemed previous such amounts of points and then redeemed by the player for other benefits. In some implementations, at least some awards associated with a given non-game-ending pattern may be differentiated between different player value categories, with one award type being provided to players of one player value category and another award type being provided to players of another player value category. For example, in some implementations, awards such as free spins or free plays may be awarded to low-or undesirable-value players to encourage them to engage in more game play (potentially turning them into average-or low-value players, respectively, or better), while awards such as exchangeable player loyalty or tracking points may be provided only to high-or average-value players, e.g., as an incentive to such players to continue the behavior that resulted in them being considered high-or average-value players.

In the table depicted in FIG. 11, it can be seen that for the first 40 numbers selected (as shown in the left column), the amounts provided for awards A and B (25 free plays, 20000 player loyalty points) in response to a bingo claim assertion made before the next number selection stay the same. This is the case all the way to the 45^{th} number selected, at which point a bingo claim assertion that is made would only result in an award of 20 free plays or 17000 player loyalty points. This would remain the case until the 50^{th} number was selected, at which point a bingo claim assertion that is made would only result in an award of 15 free plays or 14000 player loyalty points, and so forth.

Tables such as that shown in FIG. 11 may, in some cases, be replicated for players in the GUI of the Class II game that they are participating in, thereby allowing each player to make an educated decision as to whether to claim bingo on an eligible non-game-ending pattern that their bingo card may have formed or wait to see if a higher-value eligible bingo pattern might be completed on a later number selection.

As mentioned earlier herein, players participating in a Class II game session in a free-to-play context may, in some instances, earn points, such as player loyalty points, player tracking points, or the like, that may be added to cumulative total of such points and then later exchanged by such players for other benefits. In making such an exchange, the amount of points being exchanged may be subtracted from the cumulative total of such points for the player, and the exchanged-for benefit then associated with, or provided to, the player.

For example, in some such implementations, the benefits that a player may exchange such points for may include one or more of free bingo cards for use by the player in a Class II game session while being a player of the first type of player (e.g., free plays in a for-money Class II game session), one or more free spins for use in a slot machine game, a quantity of other points to be credited to the player's account another system (for example, social currency usable in a social game in order to place non-monetary wagers), one or more free bonus games, one or more vouchers redeemable for food, one or more vouchers redeemable for drinks, one or more service vouchers, one or more vouchers for a spa session, one or more vouchers for valet parking, and/or one or more vouchers for a hotel stay.

In some implementations, one or more of the prizes that may be associated with a player in connection with claiming a completed non-game-ending bingo pattern during a Class II game session in a free-to-play context may be a fixed-denomination free play award for a specified game or group of specified games. For example, such an award may be redeemed by the recipient at a gaming machine that offers the specified game or one of the specified games in the group of specified games in order to engage in a play of the specified game with a wager of the denomination specified for the award, e.g., in for-money game play. The gaming machine may treat redemption of such an award as equivalent to a real-money wager of the indicated denomination. Such awards may, however, be non-combinable with other awards. For example, as discussed above, some awards may be for points that may be banked and then combinable with points from other awards and then redeemable for another award that may be higher in value than any of the individual awards that were provided. Awards that are fixed-denomination free play awards, however, may not be combinable in such a manner. Instead, each such fixed-denomination free play award is set to a fixed wager value that cannot be altered by the player. Such an award may, for example, serve as a differentiator between different value levels of players in the free-to-play context. For example, high-value players may be awarded fixed-denomination free play awards that have a first denomination value, while average-value players may be awarded fixed-denomination free play awards having a second denomination value and low-value players may be awarded fixed denomination free play awards having a third denomination value, with the first denomination value being higher than the second denomination and the second denomination value being higher than the third denomination value. In some implementations, the fixed-denomination free play awards may be for the same game as the game in which the award was earned. For example, a player playing in a Class II game session of a particular game in a free-to-play context may be awarded with a fixed-denomination free play award for use in a Class II game session for that same particular game, but in a for-money context. This may further the goal of slowly introducing players to a Class II game in a manner that is likely to build interest in the Class II game by such players without necessarily requiring immediate buy-in by the players. Such fixed-denomination free play awards may, in effect, act as the “next step” in the player's progression-they first participate in a free-to-play context and may earn promotional awards. One of the promotional awards may, for example, be a fixed-denomination free play award that then allows the player to participate in a for-money context in that same game or type of game, potentially allowing the player to win monetary awards, but with no financial outlay by the player. Finally, the player, having experienced the Class II game in both the free-to-play and for-money contexts, may be sufficiently interested in the game to continue participating in that game by wagering their own funds in order to play.

It will be understood that a Class II game session that has players that are participating in the Class II game session in a for-money context and players that are participating in the Class II game session in a free-to-play context may, in at least some implementations, treat the players playing in these two contexts as independent sets of players in many respects-although certain aspects of the Class II game session may be common to both sets of players. For example, the numbers that are selected from the set of numbers used to populate the various bingo cards that are in use by the players may be the same for both sets of players, i.e., the same number selections are provided to both sets of players. Furthermore, when a game-ending pattern is claimed by any player in the Class II game session, this ends the Class II game session for both sets of players. In other respects, however, the two sets of players may be treated independently. For example, as discussed above, players in the two sets may be provided with different sets of eligible bingo patterns. In another example, in some instances, players participating in the Class II game session in a for-money context may only be allowed to claim completed non-game-ending bingo patterns during the “initial” number selection, e.g., when an initial quantity of numbers is selected and displayed as a group or in rapid succession without any opportunity for a player to claim a completed bingo pattern before the initial selection is complete, and may not be allowed to claim completed non-game ending bingo patterns for number selections occurring after the initial number selection (but may be allowed to claim, of course, completion of a game-ending pattern after any number selection after the initial number selection); in contrast, free-to-play context players may, in the same Class II game session, be permitted to claim non-game-ending bingo patterns both after the initial number selection and after any subsequent number selection. A further area in which the two sets of players may be treated independently from each other is in terms of the prizes that are awarded to players claiming a bingo pattern. For example, there may be one set of prizes that are awarded to players participating in the Class II game session in a for-money context that claim a non-game-ending bingo pattern, and a different set of prizes that are awarded to players participating in the Class II game session in a free-to-play context that claim a non-game-ending bingo pattern.

It will be apparent that the techniques discussed above may be executed in a variety of ways in a computing system or architecture. For example, some elements of the techniques discussed herein may be provided by a central server, such as bingo card creation and distribution, random number selection, award tracking, etc., while other elements of the techniques discussed herein may be performed by other devices, such as causing a GUI for each player to be presented on a corresponding device.

In recognition of the possibility of such distributed processing arrangements, the term “collectively” or “in aggregate,” as used herein with reference to memory devices and/or processors or various other items, should be understood to indicate that the referenced collection of items has the characteristics or provides the functionalities that are associated with that collection. For example, if a server and a client device collectively store or store, in aggregate, instructions for causing A, B, and C to occur, this encompasses at least the following scenarios:
a) The server stores instructions for causing A, B, and C to occur, but the client device stores no instructions that cause A, B, and C to occur.
b) The client device stores instructions for causing A, B, and C to occur, but the server stores no instructions that cause A, B, and C to occur.
c) The server stores instructions for causing a proper subset of A, B, and C to occur, e.g., A and B but not C, and the client device stores instructions that cause a different proper subset of A, B, and C to occur, e.g., C but not A and B, where instructions for causing each of A, B, and C to occur are respectively stored on either or both the client device and the server.
d) The server stores instructions for causing a subset of A, B, and C to occur, e.g., A and B but not C, and the client device stores instructions that cause a different subset of A, B, and C to occur, e.g., B and C but not A, where instructions for causing each of A, B, and C to occur are respectively stored on either or both the client device and the server.
e) The server stores instructions for causing A and a portion of B to occur, and the client device stores instructions that cause C and the remaining portion of B to occur.
In all of the above scenarios, between the server and the client device, there are, collectively, instructions that are stored for causing A, B, and C to occur, i.e., such instructions are stored on one or both devices and it will be recognized that using the term “collectively,” e.g., the server and the client device, collectively, store instructions for causing A, B, and C to occur, encompasses all of the above scenarios as well as additional, similar scenarios.

Similarly, a collection of processors, e.g., a first set of one or more processors and a second set of one or more processors, may be caused, collectively or in aggregate, to perform one or more actions, e.g., actions A, B, and C. As with the previous example, various permutations fall within the scope of such “collective” or “in aggregate” language:
a) The first set of one or more processors may be caused to perform each of A, B, and C, and the second set of one or more processors may not perform any of A, B, or C.
b) The second set of one or more processors may be caused to perform each of A, B, and C, and the first set of one or more processors may not perform any of A, B, or C.
c) The first set of one or more processors may be caused to perform a proper subset of A, B, and C, and the second set of one or more processors may be caused to perform a different proper subset of A, B, and C to be performed such that between the two sets of processors, all of A, B, and C are caused to be performed.
d) The first set of one or more processors may be caused to perform A and a portion of B, and the second set of one or more processors may be caused to perform C and the remainder of B.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items-it will be understood that a set or a subset can encompass only one member or multiple members (unless the context indicates otherwise).

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

It will also be understood that the present disclosure is directed at the following non-exclusive numbered implementations. Additional implementations not listed below but evident from the above discussion are also to be understood to fall within the scope of this disclosure.

Implementation 1: A system comprising:
a plurality of processors and memory devices, wherein:
   one or more of the processors are located in a server and at least some of the processors are located in devices remote from the server, and
   the memory devices store computer-executable instructions which, when executed by the processors, cause the processors, in aggregate, to:
      cause each device to present, via a display of that device, a corresponding user interface that includes a player-accessible representation of one or more bingo cards associated with that device for a first game session,
      determine, for each of the devices, whether that device is a first type of device participating in the first game session in a for-money context or a second type of device participating in the first game session in a free-to-play context,
      cause numbers to be selected from a first set of numbers for the first game session and by the server for the first game session,
      cause each of the devices to be provided with information indicating each of the numbers selected from the first set of numbers by the server, and
      receive one or more bingo claim indications for the first game session sent from one or more of the devices, wherein each bingo claim indication
         indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

Implementation 2: The system of implementation 1, wherein the memory devices store further computer-executable instructions which, when executed by the processors, further cause the processors, in aggregate, to:
cause a corresponding value level from a plurality of value levels to be established for each of the devices of the second type, wherein the corresponding value level established for each device of the second type is associated with a corresponding player account associated with that device of the second type for the first game session,
cause the set of one or more eligible bingo patterns associated with each device of the second type to be selected from a plurality of sets of one or more eligible bingo patterns based on the corresponding value level identified for that device of the second type, wherein at least two of the sets of one or more eligible bingo patterns in the plurality of sets of one or more eligible bingo patterns are different from one another.

Implementation 3: The system of implementation 2, wherein:
the plurality of value levels includes at least a first value level and a second value level,
the first value level is associated with a first set of one or more eligible bingo patterns in the plurality of sets of one or more eligible bingo patterns,
the second value level is associated with a second set of one or more eligible bingo patterns in the plurality of sets of one or more eligible bingo patterns,
the first set of one or more eligible bingo patterns has a first probability that an eligible bingo pattern in the first set of one or more eligible bingo patterns will be formed on a given bingo card during the first game session after a first quantity of numbers is selected in the first game session,
the second set of one or more eligible bingo patterns has a second probability that an eligible bingo pattern in the second set of one or more eligible bingo patterns will be formed on the given bingo card in the first game session after the first quantity of numbers is selected in the first game session, and
the first probability is higher than the second probability.

Implementation 4: The system of implementation 3, wherein:
the plurality of value levels further includes at least a third value level and a fourth value level,
the third value level is associated with a third set of one or more eligible bingo patterns in the plurality of sets of one or more eligible bingo patterns,
the fourth value level is associated with a fourth set of one or more eligible bingo patterns in the plurality of sets of one or more eligible bingo patterns,
the third set of one or more eligible bingo patterns has a third probability that an eligible bingo pattern in the third set of one or more eligible bingo patterns will be formed on a given bingo card during the first game session after the first quantity of numbers is selected in the first game session,
the fourth set of one or more eligible bingo patterns has a fourth probability that an eligible bingo pattern in the fourth set of one or more eligible bingo patterns will be formed on the given bingo card in the first game session after the first quantity of numbers is selected in the first game session,
the second probability is higher than the third probability, and
the third probability is higher than the fourth probability.

Implementation 5: The system of implementation 4, wherein:
the first set of one or more eligible bingo patterns includes patterns with one to five bingo card locations,
the second set of one or more eligible bingo patterns includes patterns with six to eight bingo card locations,
the third set of one or more eligible bingo patterns includes patterns with nine to ten bingo card locations, and
the fourth set of one or more eligible bingo patterns includes patterns with at least eleven bingo card locations.

Implementation 6: The system of implementation 3, wherein the memory devices store further computer-executable instructions which, when executed by the processors, further cause the processors, in aggregate, to:
associate, based on the corresponding value level established for each device of the second type in the first game session, a corresponding multiplier from a plurality of multipliers with that device of the second type in the first game session, and
cause a promotional award provided to a player of one of the devices of the second type in the first game session to be multiplied by the corresponding multiplier associated with that device of the second type.

Implementation 7: The system of implementation 6, wherein:
the value levels are ranked and the first value level is the highest-ranked value level,
the corresponding multiplier for each value level other than the first value level is less than or equal to the corresponding multiplier for the value level ranked one higher than that value level, and
the corresponding multiplier for the first value level is greater than the corresponding multiplier or multipliers for one or more of the other value levels.

Implementation 8: The system of implementation 7, wherein:
the plurality of value levels further includes at least a third value level and a fourth value level,
the first value level is ranked higher than the second value level,
the second value level is ranked higher than the third value level, and
the third value level is ranked higher than the fourth value level.

Implementation 9: The system of implementation 8, wherein:
the corresponding multiplier for the first value level is 2,
the corresponding multiplier for the second value level is 1.2,
the corresponding multiplier for the third value level is 1, and
the corresponding multiplier for the fourth value level is 0.1 or less.

Implementation 10: The system of implementation 1, wherein the memory devices store further computer-executable instructions which, when executed by the processors, further cause the processors, in aggregate, to:
cause a corresponding value level from a plurality of value levels to be established for each of the devices of the second type, wherein the corresponding value level established for each device of the second type is associated with a corresponding player account associated with that device of the second type for the first game session,
associate, based on the corresponding value level established for each device of the second type in the first game session, a corresponding multiplier from a plurality of multipliers with that device of the second type in the first game session, and
cause a promotional award provided to a player of the devices of the second type the first game session to be multiplied by the corresponding multiplier selected associated with that device of the second type.

Implementation 11: The system of implementation 10, wherein:
the value levels are ranked and the first value level is the highest-ranked value level,
the corresponding multiplier for each value level other than the first value level is less than or equal to the corresponding multiplier for the value level ranked one higher than that value level, and
the corresponding multiplier for the first value level is greater than the corresponding multiplier or multipliers for one or more of the other value levels.

Implementation 12: The system of implementation 11, wherein:
the plurality of value levels further includes at least a third value level and a fourth value level,
the first value level is ranked higher than the second value level,
the second value level is ranked higher than the third value level, and
the third value level is ranked higher than the fourth value level.

Implementation 13: The system of implementation 12, wherein:
the corresponding multiplier for the first value level is 2,
the corresponding multiplier for the second value level is 1.2,
the corresponding multiplier for the third value level is 1, and
the corresponding multiplier for the fourth value level is 0.1 or less.

Implementation 14: The system of implementation 1, wherein the memory devices store further computer-executable instructions which, when executed by the processors, further cause the processors, in aggregate, to:
cause, for each received bingo claim indication where the device from which that bingo claim indication was received is of the first type, a monetary award corresponding to the eligible bingo pattern for that received bingo claim indication to be associated with a player of the device from which that bingo claim indication was received, and
cause, for each received bingo claim indication where the device from which that bingo claim indication was received is of the second type, a promotional award corresponding to the eligible bingo pattern for that received bingo claim indication to be associated with a player of the device from which that bingo claim indication was received.

Implementation 15: One or more computer-readable media storing computer-executable instructions which, when executed by one or more processors, cause the one or more processors to:
cause each device of a plurality of devices to present, via a display of that device, a corresponding user interface that includes a player-accessible representation of one or more bingo cards associated with that device for a first game session,
determine, for each of the devices, whether that device is a first type of device participating in the first game session in a for-money context or a second type of device participating in the first game session in a free-to-play context,
cause numbers to be selected from a first set of numbers for the first game session and by a server for the first game session,
cause each of the devices to be provided with information indicating each of the numbers selected from the first set of numbers by the server, and
receive one or more bingo claim indications for the first game session sent from one or more of the devices, wherein each bingo claim indication indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

Implementation 16: The one or more computer-readable media of implementation 15, further storing additional computer-executable instructions which, when executed by the one or more processors, further cause the one or more processors to:
cause a corresponding value level from a plurality of value levels to be established for each of the devices of the second type, wherein the corresponding value level established for each device of the second type is associated with a corresponding player account associated with that device of the second type for the first game session,
cause the set of one or more eligible bingo patterns associated with each device of the second type to be selected from a plurality of sets of one or more eligible bingo patterns based on the corresponding value level identified for that device of the second type, wherein at least two of the sets of one or more eligible bingo patterns in the plurality of sets of one or more eligible bingo patterns are different from one another.

Implementation 17: The one or more computer-readable media of implementation 16, wherein:
the plurality of value levels includes at least a first value level and a second value level,
the first value level is associated with a first set of one or more eligible bingo patterns in the plurality of sets of one or more eligible bingo patterns,
the second value level is associated with a second set of one or more eligible bingo patterns in the plurality of sets of one or more eligible bingo patterns,
the first set of one or more eligible bingo patterns has a first probability that an eligible bingo pattern in the first set of one or more eligible bingo patterns will be formed on a given bingo card during the first game session after a first quantity of numbers is selected in the first game session,
the second set of one or more eligible bingo patterns has a second probability that an eligible bingo pattern in the second set of one or more eligible bingo patterns will be formed on the given bingo card in the first game session after the first quantity of numbers is selected in the first game session, and
the first probability is higher than the second probability.

Implementation 18: The one or more computer-readable media of implementation 17, wherein:
the plurality of value levels further includes at least a third value level and a fourth value level,
the third value level is associated with a third set of one or more eligible bingo patterns in the plurality of sets of one or more eligible bingo patterns,
the fourth value level is associated with a fourth set of one or more eligible bingo patterns in the plurality of sets of one or more eligible bingo patterns,
the third set of one or more eligible bingo patterns has a third probability that an eligible bingo pattern in the third set of one or more eligible bingo patterns will be formed on a given bingo card during the first game session after the first quantity of numbers is selected in the first game session,
the fourth set of one or more eligible bingo patterns has a fourth probability that an eligible bingo pattern in the fourth set of one or more eligible bingo patterns will be formed on the given bingo card in the first game session after the first quantity of numbers is selected in the first game session,
the second probability is higher than the third probability, and
the third probability is higher than the fourth probability.

Implementation 19: The one or more computer-readable media of implementation 18, wherein:
the first set of one or more eligible bingo patterns includes patterns with one to five bingo card locations,
the second set of one or more eligible bingo patterns includes patterns with six to eight bingo card locations,
the third set of one or more eligible bingo patterns includes patterns with nine to ten bingo card locations, and
the fourth set of one or more eligible bingo patterns includes patterns with at least eleven bingo card locations.

Implementation 20: The one or more computer-readable media of implementation 17, further storing additional computer-executable instructions which, when executed by the one or more processors, further cause the one or more processors to:
associate, based on the corresponding value level established for each device of the second type in the first game session, a corresponding multiplier from a plurality of multipliers with that device of the second type in the first game session, and
cause a promotional award provided to a player of one of the devices of the second type in the first game session to be multiplied by the corresponding multiplier associated with that device of the second type.

Implementation 21: The one or more computer-readable media of implementation 20, wherein:
the value levels are ranked and the first value level is the highest-ranked value level,
the corresponding multiplier for each value level other than the first value level is less than or equal to the corresponding multiplier for the value level ranked one higher than that value level, and
the corresponding multiplier for the first value level is greater than the corresponding multiplier or multipliers for one or more of the other value levels.

Implementation 22: The one or more computer-readable media of implementation 21, wherein:
the plurality of value levels further includes at least a third value level and a fourth value level,
the first value level is ranked higher than the second value level,
the second value level is ranked higher than the third value level, and
the third value level is ranked higher than the fourth value level.

Implementation 23: The one or more computer-readable media of implementation 20, wherein:
the corresponding multiplier for the first value level is 2,
the corresponding multiplier for the second value level is 1.2,
the corresponding multiplier for the third value level is 1, and the corresponding multiplier for the fourth value level is 0.1 or less.

Implementation 24: The one or more computer-readable media of implementation 15, further storing additional computer-executable instructions which, when executed by the one or more processors, further cause the one or more processors to:
cause a corresponding value level from a plurality of value levels to be established for each of the devices of the second type, wherein the corresponding value level established for each device of the second type is associated with a corresponding player account associated with that device of the second type for the first game session,
associate, based on the corresponding value level established for each device of the second type in the first game session, a corresponding multiplier from a plurality of multipliers with that device of the second type in the first game session, and
cause a promotional award provided to a player of the devices of the second type the first game session to be multiplied by the corresponding multiplier selected associated with that device of the second type.

Implementation 25: The one or more computer-readable media of implementation 24, wherein:
the value levels are ranked and the first value level is the highest-ranked value level,
the corresponding multiplier for each value level other than the first value level is less than or equal to the corresponding multiplier for the value level ranked one higher than that value level, and
the corresponding multiplier for the first value level is greater than the corresponding multiplier or multipliers for one or more of the other value levels.

Implementation 26: The one or more computer-readable media of implementation 25, wherein:
the plurality of value levels further includes at least a third value level and a fourth value level,
the first value level is ranked higher than the second value level,
the second value level is ranked higher than the third value level, and
the third value level is ranked higher than the fourth value level.

Implementation 27: The one or more computer-readable media of implementation 26, wherein:
the corresponding multiplier for the first value level is 2,
the corresponding multiplier for the second value level is 1.2,
the corresponding multiplier for the third value level is 1, and
the corresponding multiplier for the fourth value level is 0.1 or less.

Implementation 28: The one or more computer-readable media of implementation 15, further storing additional computer-executable instructions which, when executed by the one or more processors, further cause the one or more processors to:
cause, for each received bingo claim indication where the device from which that bingo claim indication was received is of the first type, a monetary award corresponding to the eligible bingo pattern for that received bingo claim indication to be associated with a player of the device from which that bingo claim indication was received, and
cause, for each received bingo claim indication where the device from which that bingo claim indication was received is of the second type, a promotional award corresponding to the eligible bingo pattern for that received bingo claim indication to be associated with a player of the device from which that bingo claim indication was received.

Implementation 29: A method comprising:
causing each device of a plurality of devices to present, via a display of that device, a corresponding user interface that includes a player-accessible representation of one or more bingo cards associated with that device for a first game session,
determining, for each of the devices, whether that device is a first type of device participating in the first game session in a for-money context or a second type of device participating in the first game session in a free-to-play context,
causing numbers to be selected from a first set of numbers for the first game session and by a server for the first game session,
causing each of the devices to be provided with information indicating each of the numbers selected from the first set of numbers by the server, and
receiving one or more bingo claim indications for the first game session sent from one or more of the devices, wherein each bingo claim indication indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

Implementation 30: The method of implementation 29, further comprising:
causing a corresponding value level from a plurality of value levels to be established for each of the devices of the second type, wherein the corresponding value level established for each device of the second type is associated with a corresponding player account associated with that device of the second type for the first game session,
causing the set of one or more eligible bingo patterns associated with each device of the second type to be selected from a plurality of sets of one or more eligible bingo patterns based on the corresponding value level identified for that device of the second type, wherein at least two of the sets of one or more eligible bingo patterns in the plurality of sets of one or more eligible bingo patterns are different from one another.

Implementation 31: The method of implementation 30, wherein:
the plurality of value levels includes at least a first value level and a second value level,
the first value level is associated with a first set of one or more eligible bingo patterns in the plurality of sets of one or more eligible bingo patterns,
the second value level is associated with a second set of one or more eligible bingo patterns in the plurality of sets of one or more eligible bingo patterns,
the first set of one or more eligible bingo patterns has a first probability that an eligible bingo pattern in the first set of one or more eligible bingo patterns will be formed on a given bingo card during the first game session after a first quantity of numbers is selected in the first game session,
the second set of one or more eligible bingo patterns has a second probability that an eligible bingo pattern in the second set of one or more eligible bingo patterns will be formed on the given bingo card in the first game session after the first quantity of numbers is selected in the first game session, and
the first probability is higher than the second probability.

Implementation 32: The method of implementation 31, wherein:
the plurality of value levels further includes at least a third value level and a fourth value level,
the third value level is associated with a third set of one or more eligible bingo patterns in the plurality of sets of one or more eligible bingo patterns,
the fourth value level is associated with a fourth set of one or more eligible bingo patterns in the plurality of sets of one or more eligible bingo patterns,
the third set of one or more eligible bingo patterns has a third probability that an eligible bingo pattern in the third set of one or more eligible bingo patterns will be formed on a given bingo card during the first game session after the first quantity of numbers is selected in the first game session,
the fourth set of one or more eligible bingo patterns has a fourth probability that an eligible bingo pattern in the fourth set of one or more eligible bingo patterns will be formed on the given bingo card in the first game session after the first quantity of numbers is selected in the first game session,
the second probability is higher than the third probability, and
the third probability is higher than the fourth probability.

Implementation 33: The method of implementation 32, wherein:
the first set of one or more eligible bingo patterns includes patterns with one to five bingo card locations,
the second set of one or more eligible bingo patterns includes patterns with six to eight bingo card locations,
the third set of one or more eligible bingo patterns includes patterns with nine to ten bingo card locations, and
the fourth set of one or more eligible bingo patterns includes patterns with at least eleven bingo card locations.

Implementation 34: The method of implementation 31, further comprising:
associating, based on the corresponding value level established for each device of the second type in the first game session, a corresponding multiplier from a plurality of multipliers with that device of the second type in the first game session, and
causing a promotional award provided to a player of one of the devices of the second type in the first game session to be multiplied by the corresponding multiplier associated with that device of the second type.

Implementation 35: The method of implementation 34, wherein:
the value levels are ranked and the first value level is the highest-ranked value level,
the corresponding multiplier for each value level other than the first value level is less than or equal to the corresponding multiplier for the value level ranked one higher than that value level, and
the corresponding multiplier for the first value level is greater than the corresponding multiplier or multipliers for one or more of the other value levels.

Implementation 36: The method of implementation 35, wherein:
the plurality of value levels further includes at least a third value level and a fourth value level,
the first value level is ranked higher than the second value level,
the second value level is ranked higher than the third value level, and
the third value level is ranked higher than the fourth value level.

Implementation 37: The method of implementation 34, wherein:
the corresponding multiplier for the first value level is 2,
the corresponding multiplier for the second value level is 1.2,
the corresponding multiplier for the third value level is 1, and
the corresponding multiplier for the fourth value level is 0.1 or less.

Implementation 38: The method of implementation 29, further comprising:
causing a corresponding value level from a plurality of value levels to be established for each of the devices of the second type, wherein the corresponding value level established for each device of the second type is associated with a corresponding player account associated with that device of the second type for the first game session,
associating, based on the corresponding value level established for each device of the second type in the first game session, a corresponding multiplier from a plurality of multipliers with that device of the second type in the first game session, and
causing a promotional award provided to a player of the devices of the second type the first game session to be multiplied by the corresponding multiplier selected associated with that device of the second type.

Implementation 39: The method of implementation 38, wherein:
the value levels are ranked and the first value level is the highest-ranked value level,
the corresponding multiplier for each value level other than the first value level is less than or equal to the corresponding multiplier for the value level ranked one higher than that value level, and
the corresponding multiplier for the first value level is greater than the corresponding multiplier or multipliers for one or more of the other value levels.

Implementation 40: The method of implementation 39, wherein:
the plurality of value levels further includes at least a third value level and a fourth value level,
the first value level is ranked higher than the second value level,
the second value level is ranked higher than the third value level, and
the third value level is ranked higher than the fourth value level.

Implementation 41: The one or more computer-readable media of implementation 40, wherein:
the corresponding multiplier for the first value level is 2,
the corresponding multiplier for the second value level is 1.2,
the corresponding multiplier for the third value level is 1, and
the corresponding multiplier for the fourth value level is 0.1 or less.

Implementation 42: The method of implementation 29, further comprising:
causing, for each received bingo claim indication where the device from which that bingo claim indication was received is of the first type, a monetary award corresponding to the eligible bingo pattern for that received bingo claim indication to be associated with a player of the device from which that bingo claim indication was received, and
causing, for each received bingo claim indication where the device from which that bingo claim indication was received is of the second type, a promotional award corresponding to the eligible bingo pattern for that received bingo claim indication to be associated with a player of the device from which that bingo claim indication was received.

Implementation 43: A system comprising:
a plurality of processors and memory devices, wherein:
   one or more of the processors are located in a server and at least some of the processors are located in devices remote from the server, and
   the memory devices store computer-executable instructions which, when executed by the processors, cause the processors, in aggregate, to:
      cause each device to present, via a display of that device, a corresponding user interface that includes a player-accessible representation of one or more bingo cards associated that device for a first game session,
      determine, for each of the devices, whether that device is a first type of device participating in the first game session in a for-money context or a second type of device participating in the first game session in a free-to-play context,
      cause numbers to be selected from a first set of numbers for the first game session and by the server,
      cause each of the devices to be provided with information indicating each of the numbers selected from the first set of numbers by the server for the first game session,
      receive one or more bingo claim indications for the first game session sent from one or more of the devices, wherein each bingo claim indication
         indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

Implementation 44: The system of implementation 43, wherein the memory devices store further computer-executable instructions which, when executed by the processors, further cause the processors, in aggregate, to cause promotional awards to cease being associated with a corresponding player of each device of the second type for the bingo claim indications received from that device of the second type during the first game session and after a first quantity of X numbers is selected from the first set of numbers for the first game session and before a second quantity of X+1 numbers is selected from the first set of numbers for the first game session.

Implementation 45: The system of implementation 43, wherein the memory devices store further computer-executable instructions which, when executed by the processors, further cause the processors, in aggregate, to cause the devices of the second type to cease providing bingo claim indications to the server during the first game session after a first quantity of X numbers is selected from the first set of numbers for the first game session and before a second quantity of X+1 numbers is selected from the first set of numbers for the first game session.

Implementation 46: The system of implementation 45, wherein X is greater than or equal to 45 and less than or equal to 50.

Implementation 47: The system of implementation 45, wherein X is greater than or equal to 45 and less than or equal to 47.

Implementation 48: The system of implementation 45, wherein X is 46.

Implementation 49: The system of implementation 43, wherein the memory devices store further computer-executable instructions which, when executed by the processors, further cause the processors, in aggregate, to cause the first game session to terminate after a bingo claim indication for the first game session is received from a first device of the devices remote from the server and indicates that a game-ending eligible bingo pattern has been formed on one of the one or more bingo cards associated with the first device during the first game session.

Implementation 50: The system of implementation 49, wherein the first device is of the first type and is not permitted to be of the second type for the first game session.

Implementation 51: The system of implementation 50, wherein the game-ending pattern is a blackout pattern.

Implementation 52: The system of implementation 43, wherein the memory devices store further computer-executable instructions which, when executed by the processors, further cause the processors, in aggregate, to:
track, for each player account associated with a device of the first type in the first game session and during a first time period, a corresponding quantity of bingo claim indications associated with that player account and received within the first time period and from one of the devices of the second type, and
prevent each of the devices of the second type where the corresponding quantity of the bingo claim indications associated with the player account of that device of the second type and received within the first time period exceeds a corresponding threshold amount from making a further bingo claim within the first game session.

Implementation 53: The system of implementation 52, wherein the corresponding threshold amount is one.

Implementation 54: The system of implementation 52, wherein the first time period is a 24-hour period.

Implementation 55: The system of implementation 52, wherein the first time period begins when the first game session begins and ends when the first game session ends.

Implementation 56: The system of implementation 43, wherein the memory devices store further computer-executable instructions which, when executed by the processors, further cause the processors, in aggregate, to cause the user interface presented on each device of the second type to provide player-accessible representations of multiple bingo cards for the first game session.

Implementation 57: The system of implementation 43, wherein the memory devices store further computer-executable instructions which, when executed by the processors, further cause the processors, in aggregate, to:
conduct multiple game sessions within a first time period, the multiple game sessions including the first game session, and
limit to a predetermined number a quantity of the game sessions within the first time period that a player account can participate in while being associated with a device of the second type.

Implementation 58: The system of implementation 57, wherein the predetermined number is six.

Implementation 59: The system of implementation 57, wherein each of the devices of the second type participating in one of the game sessions during the first time period and associated with a common player account during each of the game sessions is caused to present a player-accessible representation of only one bingo card for that game session.

Implementation 60: The system of implementation 43, wherein the memory devices store further computer-executable instructions which, when executed by the processors, further cause the processors, in aggregate, to:
track, for each player account associated with one of the devices of the second type during the first game session, a cumulative total of any promotional awards associated with that player account as a result of participating in the first game session, and
cause, responsive to receipt of a request from a first player associated with a first player account of the player accounts, an interface to be presented that allows the first player to exchange some or all of the cumulative total of promotional awards associated with the player account of the first player for one or more awards.

Implementation 61: The system of implementation 60, wherein the one or more awards include one or more of free bingo cards for use on the devices while the first player is participating in a game session while being a player of the first type of player, one or more free spins for use in a slot machine game, a quantity of points to be credited to the first player's account in a player loyalty program, one or more free bonus games, one or more vouchers redeemable for food, one or more vouchers redeemable for drinks, one or more service vouchers, one or more vouchers for a spa session, one or more vouchers for valet parking, and one or more vouchers for a hotel stay.

Implementation 62: One or more computer-readable media storing computer-executable instructions which, when executed by one or more processors, cause the one or more processors to:
cause each device of a plurality of devices to present, via a display of that device, a corresponding user interface that includes a player-accessible representation of one or more bingo cards associated that device for a first game session,
determine, for each of the devices, whether that device is a first type of device participating in the first game session in a for-money context or a second type of device participating in the first game session in a free-to-play context,
cause numbers to be selected from a first set of numbers for the first game session and by a server,
cause each of the devices to be provided with information indicating each of the numbers selected from the first set of numbers by the server for the first game session,
receive one or more bingo claim indications for the first game session sent from one or more of the devices, wherein each bingo claim indication indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

Implementation 63: The one or more computer-readable media of implementation 62, further storing additional computer-executable instructions which, when executed by the one or more processors, further cause the one or more processors to cause promotional awards to cease being associated with a corresponding player of each device of the second type for the bingo claim indications received from that device of the second type during the first game session and after a first quantity of X numbers is selected from the first set of numbers for the first game session and before a second quantity of X+1 numbers is selected from the first set of numbers for the first game session.

Implementation 64: The one or more computer-readable media of implementation 62, further storing additional computer-executable instructions which, when executed by the one or more processors, further cause the one or more processors to cause the devices of the second type to cease providing bingo claim indications to the server during the first game session after a first quantity of X numbers is selected from the first set of numbers for the first game session and before a second quantity of X+1 numbers is selected from the first set of numbers for the first game session.

Implementation 65: The one or more computer-readable media of implementation 64, wherein X is greater than or equal to 45 and less than or equal to 50.

Implementation 66: The one or more computer-readable media of implementation 64, wherein X is greater than or equal to 45 and less than or equal to 47.

Implementation 67: The one or more computer-readable media of implementation 64, wherein X is 46.

Implementation 68: The one or more computer-readable media of implementation 62, further storing additional computer-executable instructions which, when executed by the one or more processors, further cause the one or more processors to cause the first game session to terminate after a bingo claim indication for the first game session is received from a first device of the devices remote from the server and indicates that a game-ending eligible bingo pattern has been formed on one of the one or more bingo cards associated with the first device during the first game session.

Implementation 69: The one or more computer-readable media of implementation 68, wherein the first device is of the first type and is not permitted to be of the second type for the first game session.

Implementation 70: The one or more computer-readable media of implementation 69, wherein the game-ending pattern is a blackout pattern.

Implementation 71: The one or more computer-readable media of implementation 62, further storing additional computer-executable instructions which, when executed by the one or more processors, further cause the one or more processors to:
track, for each player account associated with a device of the first type in the first game session and during a first time period, a corresponding quantity of bingo claim indications associated with that player account and received within the first time period and from one of the devices of the second type, and
prevent each of the devices of the second type where the corresponding quantity of the bingo claim indications associated with the player account of that device of the second type and received within the first time period exceeds a corresponding threshold amount from making a further bingo claim within the first game session.

Implementation 72: The one or more computer-readable media of implementation 71, wherein the corresponding threshold amount is one.

Implementation 73: The one or more computer-readable media of implementation 71, wherein the first time period is a 24-hour period.

Implementation 74: The one or more computer-readable media of implementation 71, wherein the first time period begins when the first game session begins and ends when the first game session ends.

Implementation 75: The one or more computer-readable media of implementation 62, further storing additional computer-executable instructions which, when executed by the one or more processors, further cause the one or more processors to cause the user interface presented on each device of the second type to provide player-accessible representations of multiple bingo cards for the first game session.

Implementation 76: The one or more computer-readable media of implementation 62, further storing additional computer-executable instructions which, when executed by the one or more processors, further cause the one or more processors to:
conduct multiple game sessions within a first time period, the multiple game sessions including the first game session, and
limit to a predetermined number a quantity of the game sessions within the first time period that a player account can participate in while being associated with a device of the second type.

Implementation 77: The one or more computer-readable media of implementation 76, wherein the predetermined number is six.

Implementation 78: The one or more computer-readable media of implementation 76, wherein each of the devices of the second type participating in one of the game sessions during the first time period and associated with a common player account during each of the game sessions is caused to present a player-accessible representation of only one bingo card for that game session.

Implementation 79: The one or more computer-readable media of implementation 62, wherein the memory devices store further computer-executable instructions which, when executed by the processors, further cause the processors, in aggregate, to:
track, for each player account associated with one of the devices of the second type during the first game session, a cumulative total of any promotional awards associated with that player account as a result of participating in the first game session, and
cause, responsive to receipt of a request from a first player associated with a first player account of the player accounts, an interface to be presented that allows the first player to exchange some or all of the cumulative total of promotional awards associated with the player account of the first player for one or more awards.

Implementation 80: The one or more computer-readable media of implementation 79, wherein the one or more awards include one or more of free bingo cards for use on the devices while the first player is participating in a game session while being a player of the first type of player, one or more free spins for use in a slot machine game, a quantity of points to be credited to the first player's account in a player loyalty program, one or more free bonus games, one or more vouchers redeemable for food, one or more vouchers redeemable for drinks, one or more service vouchers, one or more vouchers for a spa session, one or more vouchers for valet parking, and one or more vouchers for a hotel stay.

Implementation 81: A method comprising:
causing each device of a plurality of devices to present, via a display of that device, a corresponding user interface that includes a player-accessible representation of one or more bingo cards associated that device for a first game session,
determining, for each of the devices, whether that device is a first type of device participating in the first game session in a for-money context or a second type of device participating in the first game session in a free-to-play context,
causing numbers to be selected from a first set of numbers for the first game session and by a server,
causing each of the devices to be provided with information indicating each of the numbers selected from the first set of numbers by the server for the first game session,
receiving one or more bingo claim indications for the first game session sent from one or more of the devices, wherein each bingo claim indication indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

Implementation 82: The method of implementation 81, further comprising causing promotional awards to cease being associated with a corresponding player of each device of the second type for the bingo claim indications received from that device of the second type during the first game session and after a first quantity of X numbers is selected from the first set of numbers for the first game session and before a second quantity of X+1 numbers is selected from the first set of numbers for the first game session.

Implementation 83: The method of implementation 81, further comprising causing the devices of the second type to cease providing bingo claim indications to the server during the first game session after a first quantity of X numbers is selected from the first set of numbers for the first game session and before a second quantity of X+1 numbers is selected from the first set of numbers for the first game session.

Implementation 84: The method of implementation 83, wherein X is greater than or equal to 45 and less than or equal to 50.

Implementation 85: The method of implementation 83, wherein X is greater than or equal to 45 and less than or equal to 47.

Implementation 86: The method of implementation 83, wherein X is 46.

Implementation 87: The method of implementation 81, further comprising causing the first game session to terminate after a bingo claim indication for the first game session is received from a first device of the devices remote from the server and indicates that a game-ending eligible bingo pattern has been formed on one of the one or more bingo cards associated with the first device during the first game session.

Implementation 88: The method of implementation 87, wherein the first device is of the first type and is not permitted to be of the second type for the first game session.

Implementation 89: The method of implementation 88, wherein the game-ending pattern is a blackout pattern.

Implementation 90: The method of implementation 81, further comprising:
tracking, for each player account associated with a device of the first type in the first game session and during a first time period, a corresponding quantity of bingo claim indications associated with that player account and received within the first time period and from one of the devices of the second type, and
preventing each of the devices of the second type where the corresponding quantity of the bingo claim indications associated with the player account of that device of the second type and received within the first time period exceeds a corresponding threshold amount from making a further bingo claim within the first game session.

Implementation 91: The method of implementation 90, wherein the corresponding threshold amount is one.

Implementation 92: The method of implementation 90, wherein the first time period is a 24-hour period.

Implementation 93: The method of implementation 90, wherein the first time period begins when the first game session begins and ends when the first game session ends.

Implementation 94: The method of implementation 81, further comprising causing the user interface presented on each device of the second type to provide player-accessible representations of multiple bingo cards for the first game session.

Implementation 95: The method of implementation 81, further comprising:
conducting multiple game sessions within a first time period, the multiple game sessions including the first game session, and
limiting to a predetermined number a quantity of the game sessions within the first time period that a player account can participate in while being associated with a device of the second type.

Implementation 96: The method of implementation 95, wherein the predetermined number is six.

Implementation 97: The method of implementation 95, wherein each of the devices of the second type participating in one of the game sessions during the first time period and associated with a common player account during each of the game sessions is caused to present a player-accessible representation of only one bingo card for that game session.

Implementation 98: The method of implementation 81, further comprising:
tracking, for each player account associated with one of the devices of the second type during the first game session, a cumulative total of any promotional awards associated with that player account as a result of participating in the first game session, and
causing, responsive to receipt of a request from a first player associated with a first player account of the player accounts, an interface to be presented that allows the first player to exchange some or all of the cumulative total of promotional awards associated with the player account of the first player for one or more awards.

Implementation 99: The method of implementation 98, wherein the one or more awards include one or more of free bingo cards for use on the devices while the first player is participating in a game session while being a player of the first type of player, one or more free spins for use in a slot machine game, a quantity of points to be credited to the first player's account in a player loyalty program, one or more free bonus games, one or more vouchers redeemable for food, one or more vouchers redeemable for drinks, one or more service vouchers, one or more vouchers for a spa session, one or more vouchers for valet parking, and one or more vouchers for a hotel stay.

1. A system comprising:
a plurality of processors and memory devices, wherein:
one or more of the processors are located in a server and at least some of the processors are located in devices remote from the server, and
the memory devices store computer-executable instructions which, when executed by the processors, cause the processors, in aggregate, to:
cause each device to present, via a display of that device, a corresponding user interface that includes a player-accessible representation of one or more bingo cards associated with that device for a first game session,
determine, for each of the devices, whether that device is a first type of device participating in the first game session in a for-money context or a second type of device participating in the first game session in a free-to-play context,
cause numbers to be selected from a first set of numbers for the first game session and by the server,
cause each of the devices to be provided with information indicating each of the numbers selected from the first set of numbers by the server for the first game session,
receive one or more bingo claim indications for the first game session sent from one or more of the devices, wherein each bingo claim indication
indicates that the device from which that bingo claim indication was received made a claim that one or more of the numbers selected by the server for the first game session match a corresponding number or numbers in one or more locations on one of the one or more bingo cards associated with the device from which that bingo claim indication was received that form a pattern that matches an eligible bingo pattern of one or more eligible bingo patterns associated with the device from which that bingo claim indication was received.

2. The system of claim 1, wherein the memory devices store further computer-executable instructions which, when executed by the processors, further cause the processors, in aggregate, to cause promotional awards to cease being associated with a corresponding player of each device of the second type for the bingo claim indications received from that device of the second type during the first game session and after a first quantity of X numbers is selected from the first set of numbers for the first game session and before a second quantity of X+1 numbers is selected from the first set of numbers for the first game session.

3. The system of claim 1, wherein the memory devices store further computer-executable instructions which, when executed by the processors, further cause the processors, in aggregate, to cause the devices of the second type to cease providing bingo claim indications to the server during the first game session after a first quantity of X numbers is selected from the first set of numbers for the first game session and before a second quantity of X+1 numbers is selected from the first set of numbers for the first game session.

4. The system of claim 3, wherein X is greater than or equal to 45 and less than or equal to 50.

5. The system of claim 3, wherein X is greater than or equal to 45 and less than or equal to 47.

6. The system of claim 3, wherein X is 46.

7. The system of claim 1, wherein the memory devices store further computer-executable instructions which, when executed by the processors, further cause the processors, in aggregate, to cause the first game session to terminate after a bingo claim indication for the first game session is received from a first device of the devices remote from the server and indicates that a game-ending eligible bingo pattern has been formed on one of the one or more bingo cards associated with the first device during the first game session.

8. The system of claim 7, wherein the first device is of the first type and is not permitted to be of the second type for the first game session.

9. The system of claim 8, wherein the game-ending pattern is a blackout pattern.

10. The system of claim 1, wherein the memory devices store further computer-executable instructions which, when executed by the processors, further cause the processors, in aggregate, to:
track, for each player account associated with a device of the first type in the first game session and during a first time period, a corresponding quantity of bingo claim indications associated with that player account and received within the first time period and from one of the devices of the second type, and
prevent each of the devices of the second type where the corresponding quantity of the bingo claim indications associated with the player account of that device of the second type and received within the first time period exceeds a corresponding threshold amount from making a further bingo claim within the first game session.

11. The system of claim 10, wherein the corresponding threshold amount is one.

12. The system of claim 10, wherein the first time period is a 24-hour period.

13. The system of claim 10, wherein the first time period begins when the first game session begins and ends when the first game session ends.

14. The system of claim 1, wherein the memory devices store further computer-executable instructions which, when executed by the processors, further cause the processors, in aggregate, to cause the user interface presented on each device of the second type to provide player-accessible representations of multiple bingo cards for the first game session.

15. The system of claim 1, wherein the memory devices store further computer-executable instructions which, when executed by the processors, further cause the processors, in aggregate, to:
conduct multiple game sessions within a first time period, the multiple game sessions including the first game session, and
limit to a predetermined number a quantity of the game sessions within the first time period that a player account can participate in while being associated with a device of the second type.

16. The system of claim 15, wherein the predetermined number is six.

17. The system of claim 15, wherein each of the devices of the second type participating in one of the game sessions during the first time period and associated with a common player account during each of the game sessions is caused to present a player-accessible representation of only one bingo card for that game session.

18. The system of claim 1, wherein the memory devices store further computer-executable instructions which, when executed by the processors, further cause the processors, in aggregate, to:
track, for each player account associated with one of the devices of the second type during the first game session, a cumulative total of any promotional awards associated with that player account as a result of participating in the first game session, and
cause, responsive to receipt of a request from a first player associated with a first player account of the player accounts, an interface to be presented that allows the first player to exchange some or all of the cumulative total of promotional awards associated with the player account of the first player for one or more awards.

19. The system of claim 18, wherein the one or more awards include one or more of free bingo cards for use on the devices while the first player is participating in a game session while being a player of the first type of player, one or more free spins for use in a slot machine game, a quantity of points to be credited to the first player's account in a player loyalty program, one or more free bonus games, one or more vouchers redeemable for food, one or more vouchers redeemable for drinks, one or more service vouchers, one or more vouchers for a spa session, one or more vouchers for valet parking, and one or more vouchers for a hotel stay.

20-57. (canceled)
